(19) United States
(12) Patent Application Publication
(10) Pub. No.: US 2017/0330246 A1
(43) Pub. Date: Nov. 16, 2017

(54) SYSTEM, USER MANAGING SERVER, AND METHOD OF PROVIDING USER CUSTOMIZED ADVERTISEMENT

(71) Applicant: Encored Technologies, Inc., Seoul (KR)

(72) Inventors: Jong-Woong Choe, Seoul (KR); Hyoseop Lee, Seoul (KR); Seonjeong Lee, Seoul (KR); Evan Bruns, Seoul (KR); Heejun Kong, Seoul (KR)

(21) Appl. No.: 15/271,331

(22) Filed: Sep. 21, 2016

(30) Foreign Application Priority Data
May 16, 2016 (KR) 10-2016-0059825

(51) Int. Cl. G06Q 30/02

(52) U.S. Cl. CPC G06Q 30/0276; G06Q 30/0269

(57) ABSTRACT

The present invention relates to a technique for providing a user customized advertisement, and more particularly, to a system, user managing server, and method for providing a user customized advertisement based on a user profile in which a power consumption pattern of the user is reflected. According to the present invention, the system of providing a customized advertisement system includes a user managing server which generates a user profile based on a first user information of user identification and a second user information on a power usage pattern, an advertisement providing server which selects a user customized advertisement based on the generated user profile, and a user terminal which receives and outputs the selected user customized advertisement from the advertisement providing server.

### CROSS-REFERENCE TO RELATED APPLICATIONS

This application claims priority to and the benefit of Korean Patent Application No. 10-2016-0059825 filed in the Korean Intellectual Property Office on May 16, 2016, the entire contents of which are incorporated herein by reference.

### TECHNICAL FIELD

The present invention relates to a technique for providing a user customized advertisement, and more particularly, to a technique for providing a user customized advertisement based on a user profile in which a power consumption pattern of load apparatus for every user is considered.

### BACKGROUND ART

In recent years, as a user customized advertising service, advertisement of a product/service having a high interest/purchasing possibility of a user is provided to a user terminal based on a purchasing history of the user, an on-line site visiting history, and a product/service searching history on-line. However, the above-described user customized advertising service is provided only based on activity information of the user through online connection so that a tendency of the user when the user does not access online is not considered. Therefore, an application field is limited.

However, when a customized advertisement is produced based on power consumption information of the user, a behavior of the user may be figured out even when the user does not access online. Therefore, a new customized advertising service field may be created. However, in the related art, there is a limitation for obtaining individual energy usage information of the user for providing a user customized advertising service due to an energy measurement related plant and equipment investment or absence of processing/storing/managing flexibility of a large quantity of big data.

### SUMMARY OF THE INVENTION

The present invention has been made in an effort to provide a system, a user managing server, and a method which provide a user customized advertisement based on a user profile generated in consideration of information on user identification and information on a power consumption pattern of a user.

Further, the present invention has been made in an effort to provide a system, a user managing server, and a method for providing a user customized advertisement which predict a user behavior or a user tendency based on a power consumption pattern and provide a user customized advertisement corresponding to a user's demand expected in accordance with the user behavior or tendency.

Furthermore, the present invention has been made in an effort to provide a system, a user managing server, and a method for providing a user customized advertisement which monitors a power consuming situation for every load apparatus used by the user through an energy measuring apparatus, so that the user does not need to directly input the power consumption pattern.

According to an aspect of the present invention, a system for providing a user customized advertisement includes a user managing server which generates a user profile based on first user information on user identification and second user information on a power consumption pattern; an advertisement providing server which selects a user customized advertisement based on the generated user profile; and a user terminal which receives and outputs the selected user customized advertisement from the advertisement providing device.

In the exemplary embodiment, the first user information may include at least one of a name, an ID, a gender, an address, load apparatus identification information, and favorite information. The second user information may be information on power consumption of a user for every load apparatus and may include at least one of power information at every time zone, status information, and frequency information. The user profile may include at least one of a user's behavior and a user's tendency which are estimated based on the first and second user information.

In the exemplary embodiment, the user managing server may predict a user's demand based on at least one of the user's behavior and the user's tendency estimated above and transmit the predicted user's demand to the advertisement providing server. In this case, the advertisement providing server may select the user customized advertisement in consideration of the predicted user demand.

In the exemplary embodiment, the user managing server may collect the user's current status information to transmit the information to the advertisement providing server. In this case, the advertisement providing server may select the user customized advertisement in consideration of the current status information of the user.

In the exemplary embodiment, the user managing server may generate the user profile based on a pattern based algorithm. More specifically, the user managing server may figure out at least one of the power consumption pattern and the power consumption characteristic for every user using the pattern based algorithm and reflect at least one of the figured-out power consumption pattern and power consumption characteristic to generate the user profile.

In the exemplary embodiment, the user managing server may perform security communication with at least one of the user terminal, the advertisement providing server, the energy measuring apparatus, and the labeling server.

The system for providing a user customized advertisement may further include an energy measuring apparatus which obtains a data set on power consumption in accordance with an operation status of each of load apparatus of the user or a changing pattern of the operation status. In this case, the user managing server may label the data set received from the energy measuring apparatus and obtain the second user information from the labeled data set.

The system for providing a user customized advertisement may further include an energy measuring apparatus which obtains a data set on power consumption in accordance with an operation status of each of load apparatus of the user or a changing pattern of the operation status; and a labeling server which labels the data set received from the energy measuring apparatus. At this time, the user managing server may receive the data set labeled from the labeling server and obtain the second user information from the received labeled data set.

According to another aspect of the present invention, a user managing server which provides a user customized advertisement includes comprising: a user information managing module which obtains and manages first user information on user identification and second user information on a power consumption pattern; a user profile generating module which generates a user profile based on the first and second user information; a communication module which transmits predetermined information required to select a user customized advertisement based on the user profile to the advertisement providing server; and a control module which controls an operation of at least one of the user information managing module, the user profile generating module, and the communication module.

In the exemplary embodiment, wherein the user information managing module may include a first user information managing module which obtains and manages the first information including at least one of a name, an ID, a gender, an address, load apparatus identification number, and favorite information, and a second user information managing module which obtains and manages the second user information including at least one of power information at every time zone, status information, and frequency information as information on power consumption of a user for every load apparatus.

In the exemplary embodiment, the user profile generating module may predict at least one of the user's behavior and the user's tendency based on the first and second user information and reflect at least one of the predicted user's behavior and user's tendency to the user profile.

In the exemplary embodiment, the user profile generating module may generate the user profile based on a pattern based algorithm.

In the exemplary embodiment, the communication module may receive a data set which matches an operation status of each load apparatus of the user or a changing pattern of the operation status from the labeling server, and the user information managing module may obtain the second user information from the received data set.

In the exemplary embodiment, the communication module may perform security communication with at least one of the advertisement providing server, the energy measuring apparatus, the labeling server, and the user terminal.

Further, the server may further include a user demand predicting module which predicts a user demand based on at least one of the predicted user's behavior and user's tendency in accordance with the control of the control module. In this case, the communication module transmits the predicted user demand to the advertisement providing server to be considered to select the user customized advertisement.

The server may further include a user status collecting module which collects the user's current status information. In this case, the communication module transmits the collected user's current status information to the advertisement providing server to be considered to select the user customized advertisement.

The serve may further include a labeling module which labels a data set which matches an operation status of each load apparatus of the user or a changing pattern of the operation status. In this case, the user information managing module obtains the second user information from the labeled data set.

According to another aspect of the present invention, a method for providing a user customized advertisement includes: obtaining first user information on user identification and second user information on a power consumption pattern; generating a user profile based on the obtained first and second user information; selecting a user customized advertisement based on the generated user profile; and transmitting the selected user customized advertisement to a user terminal.

In the exemplary embodiment, the generating may include: predicting at least one of a user's behavior and a user's tendency based on the first and second user information; and reflecting at least one of the predicted user's behavior and user's tendency to the user profile.

In the generating, the user profile may be generated using a pattern based algorithm.

The method may further include predicting a user's demand based on at least one of the predicted user's behavior and user's tendency. In this case, in the selecting, the user customized advertisement may be selected in consideration of the predicted user demand.

The method may further include collecting current status information of the user. In this case, in the selecting, the user customized advertisement may be selected in consideration of the collected current status of the user.

The method may further include: collecting a data set on power consumption in accordance with an operation status of each of load apparatus of the user or a changing pattern of the operation status; and labeling the collected data set. In this case, in the obtaining, the second user information may be obtained from the labeled data set.

According to still another aspect of the present invention, a method for providing a user customized advertisement includes providing a first interface on a user profile, by a service providing device; requesting information on a first user who satisfies a first condition among the user profile based on the first condition input through the first interface to the data providing server, by the service providing device; providing a second interface using information on a first user provided from the data providing server, by the service providing device; requesting an approval based on advertisement contents input through the second interface, by the service providing device; and requesting the data server to provide the advertising contents to target apparatus when the approval is completed, by the service providing device.

In the exemplary embodiment, the requesting of approval may include outputting the approved interface through an output unit and requesting the approval through the output approved interface by the service providing device.

In the exemplary embodiment, the requesting of approval may include requesting an approval signal to an approving device, by the service providing device.

In the exemplary embodiment, the second interface classifies and outputs the information on the first user in accordance with the second condition which is different from the first condition.

In the exemplary embodiment, the method may further include providing the advertisement contents to the target apparatus when the approval is completed, by the data providing server.

According to another aspect of the present invention, a method for providing a user customized advertisement includes receiving the first condition, by a data providing server, to provide information on a first user which satisfies the first condition among user profiles to a service providing device; and receiving the completely approved advertising contents by the data providing server to provide the completely approved advertising contents to the target apparatus.

In the exemplary embodiment, the receiving of the completely approved advertising contents, by the data providing server, may include receiving the advertising contents and an approval signal indicating that the advertising contents is approved by an approver.

According to still another aspect of the present invention, A user customized advertising system, comprising: a data providing server which provides information on a first user who satisfies the first condition among user profiles generated based on the information on user identification and information on a power consumption pattern and receives the advertising contents to provide the advertising contents to a target device; and a service providing device which requests the information on the first user who satisfies a first condition to the data providing server and receives the advertising contents using information on the first user to request to approve the advertising contents. In this case, the advertising contents which are provided by the data providing server to the target device may be advertising contents which is completely approved as requested by the service providing device.

In the exemplary embodiment, the service providing device may include an output unit which outputs an interface which receives the first condition and the advertising contents; a data processing unit which provides an input provided through the output unit to the data providing server; and an approving unit which requests an approval on the input advertising contents and provides the result to the data providing server.

In the exemplary embodiment, the system may further include an approving device which processes an approval of the advertising contents.

According to the present invention, it is possible to provide a user customized advertisement based on a user profile generated in accordance with information on user identification and information on a power consumption pattern of a user of load apparatus.

According to the present invention, a user's demand related with a product/service is figured out based on a user profile to provide a user customized advertisement corresponding to the figured out user's demand.

According to the present invention, it is possible to provide a user customized advertisement at an appropriate time when the advertisement is required because the user customized advertisement is selected and provided in consideration of a user's current status.

### BRIEF DESCRIPTION OF THE DRAWINGS

FIG. 1 is a block diagram illustrating an energy measuring apparatus at a power penetration point, according to an embodiment as disclosed herein.

FIGS. 2A, 2B, and 2C are flowcharts illustrating various operations of each component of the energy measuring apparatus at a power penetration point, according to an embodiment as disclosed herein.

FIG. 3 is a flow chart illustrating various operations performed by the energy measuring apparatus for load management between the energy measuring apparatus and the server, according to an embodiment as disclosed herein.

FIG. 4 is a flow chart illustrating various operations performed by the server for load management between the energy measuring apparatus and the server, according to an embodiment as disclosed herein.

FIG. 5 is a block diagram illustrating a labeling server, according to an embodiment as disclosed herein.

FIG. 6 is a flowchart illustrating various operation of the labeling server, according to an embodiment as disclosed herein.

FIG. 7 is a view of a configuration of a system for providing a user customized advertisement according to an exemplary embodiment of the present invention.

FIG. 8 is a view of a configuration of a server in which a labeling server and a user managing server are combined according to an exemplary embodiment of the present invention.

FIG. 9 is a flowchart of a method for providing a user customized advertisement according to an exemplary embodiment of the present invention.

FIG. 10 is a view of a configuration of a user managing server for providing a user customized advertisement according to an exemplary embodiment of the present invention.

FIG. 11 is a view of a configuration of an advertisement providing server for providing a user customized advertisement according to an exemplary embodiment of the present invention.

FIGS. 12A and 12B illustrate a plurality of pattern samples which is used for a pattern based algorithm according to an exemplary embodiment of the present invention.

FIGS. 13A and 13B illustrate an actual power consumption pattern generated in accordance with a 10-pattern based algorithm according to an exemplary embodiment of the present invention.

FIGS. 14A and 14B illustrate an actual power consumption pattern generated in accordance with a 6-pattern based algorithm according to an exemplary embodiment of the present invention.

FIG. 15 is a conceptual block diagram of a user customized advertising system according to some exemplary embodiments of the present invention.

FIG. 16 is a detailed block diagram of a data providing server of FIG. 5.

FIG. 17 is a detailed block diagram of a service providing device of FIG. 5.

FIG. 18 is a flowchart of a method for providing a user customized advertisement according to some exemplary embodiments of the present invention.

FIGS. 19 to 24 are views for explaining a method for providing a user customized advertisement according to some exemplary embodiments of the present invention.

FIG. 25 is a conceptual block diagram of a user customized advertising system according to other some exemplary embodiments of the present invention.

FIG. 26 is a conceptual block diagram of a user customized advertising system according to other some exemplary embodiments of the present invention.

### DETAILED DESCRIPTION

The following description illustrates only a principle of the present invention. Therefore, those skilled in the art may implement the principle of the invention and create various devices within a concept and a scope of the invention even though not clearly described or illustrated in the specification. Further, it is understood that all conditional terminologies and exemplary embodiments described in the specification are apparently intended only for understanding the concept of the invention but the invention is not limited to specifically describe exemplary embodiments and status.

The above objects, features, and advantages will be more obvious from the detailed description with reference to the accompanying drawings, and the technical spirit of the present invention may be easily carried out by those skilled in the art.

However, in describing the present invention, if it is considered that a specific description of related known configuration or function may unnecessarily cloud the gist of the present invention, the description thereof will be omitted. Hereinafter, exemplary embodiments will be described with reference to accompanying drawings.

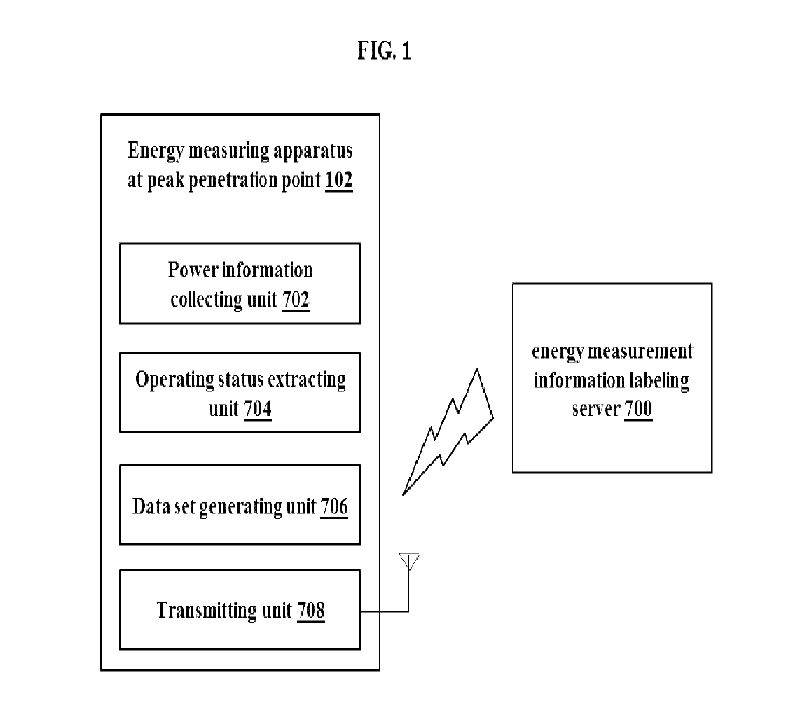

Hereinafter, referring to the FIGS. 1 to 6, an energy measuring apparatus at a penetration point of power and a labeling server 700 generating power information by labeling a data set received therefrom, according to an embodiment of the present invention will be described.

FIG. 1 is a block diagram illustrating an energy measuring apparatus 102 at a power penetration point, according to an embodiment as disclosed herein. In the embodiment, the energy measuring apparatus 102 can be configured to generate an unregistered load clustering data set in order to individually estimate energy consumption information of each load apparatus connected to the power penetration point and transmits the estimated energy consumption information to an energy measurement information labeling server 700.

The energy measuring apparatus 102 described herein is installed together with a single sensor at the power penetration point. The energy measuring apparatus 102 performs a series of operations to measure total electric energy consumption and estimate energy consumption of each load apparatus. Unlike the conventional systems and methods, a previous information processing process performed for each load apparatus is summarized below.

First, a snapshot is extracted from a signal of voltage or current. Noise filtering is performed by extracting a reference point. Normal or excessive statuses of the voltage, active power, reactive power, or the like are distinguished based on a corresponding result, and operating statuses. An operating status change such as an on or off event of the individual load apparatuses are extracted through the distinguished normal or excessive statuses. In addition, a final clustering data set is generated by pattern matching load classification through a voltage-current correlation, a high-frequency distortion, a current or power snapshot signal deformation, an active or reactive power correlation, or the like associated with a load feature. Further, the generated clustering data set is transmitted to the energy measurement information labeling server 700 or cloud through data compression in an unregistered status. For example, load classification mark such as 1, 2, 3 or A, B, C, or the like may not be a registered status and may not be recognized to a user.

The energy measuring apparatus 102 can include a power information collecting unit 702, an operating status extracting unit 704, a data set generating unit 706, and a transmitting unit 708.

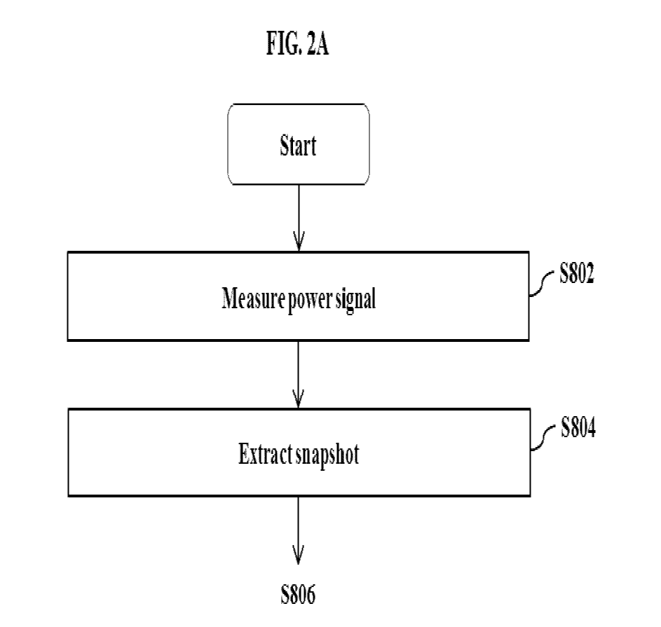

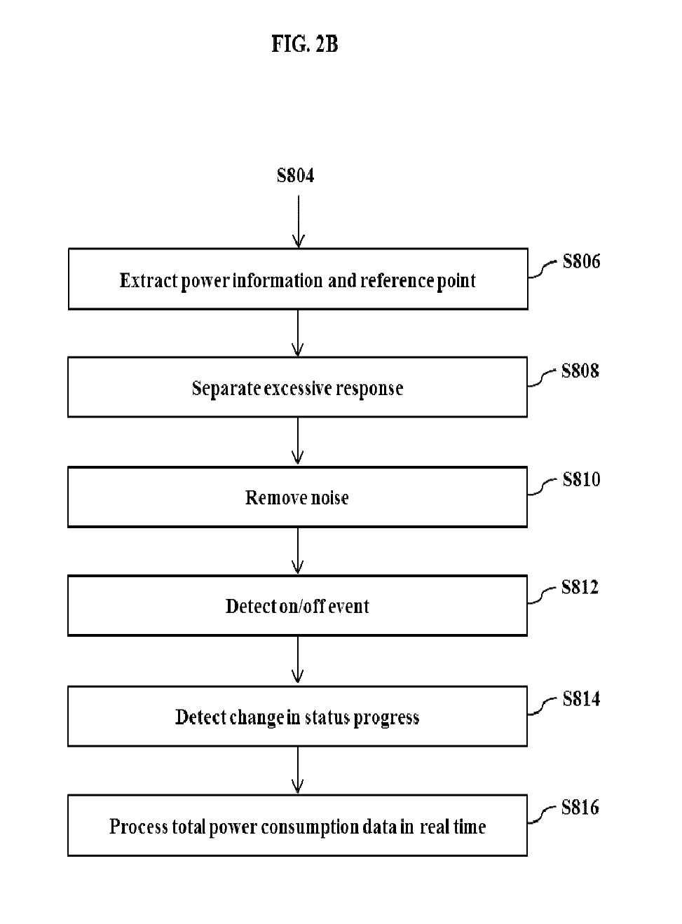

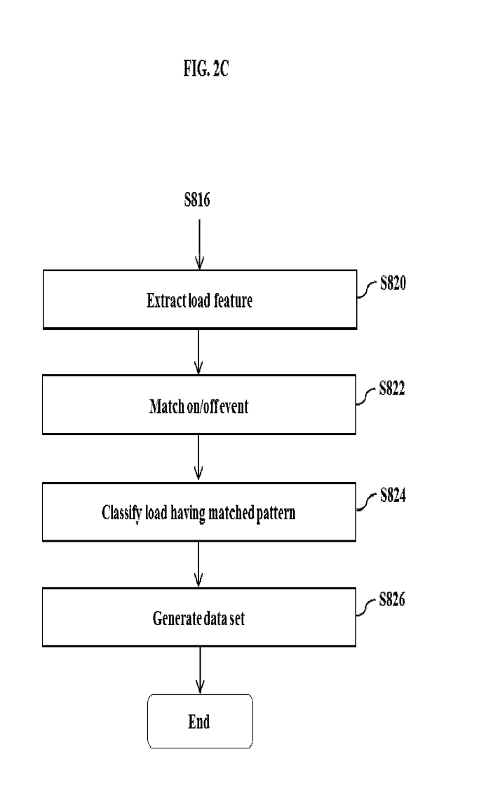

In an embodiment, the power information collecting unit 702 can be configured to collect energy or power information including a power signal at the power penetration point for a plurality of load apparatuses. The load apparatus described herein can include energy using apparatuses or components using electric energy. In an embodiment, the load apparatus can include both the individual energy apparatus such as television, refrigerator, or the like and the component unit such as motor, light, or the like. The power penetration point can be, for example, a node into which power penetrates with respect to the plurality of load apparatuses such as the power penetration point of a panel board or a distribution board of a household. Further, the various operations performed by the power information collecting unit 702 are described in detail in conjunction with FIG. 2A.

In an embodiment, the operating status extracting unit 704 can be configured to distinguish between a normal or excessive status of a power change from the collected voltage or power information to extract an operating status or a change pattern of the operating status of the load apparatus. Further, the various operations performed by the operating status extracting unit 704 are described in detail in conjunction with FIG. 2B.

In an embodiment, the data set generating unit 706 can be configured to generate a data set for each of the individual load apparatuses which matches the operating status or the change pattern of the operating status through a signal correlation depending on power usage information of the individual load apparatuses. The various operations performed by the data set generating unit 706 are described in detail in conjunction with FIG. 2C.

When the data sets are generated, the transmitting unit 708 can be configured to transmit the generated data sets to the energy measurement information labeling server 700 that generates labeled power information by recombining the data sets.

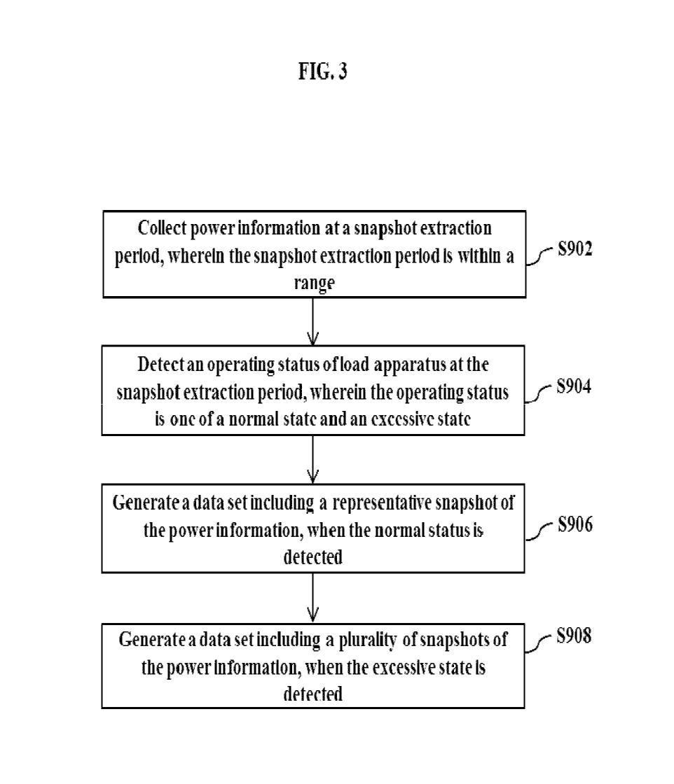

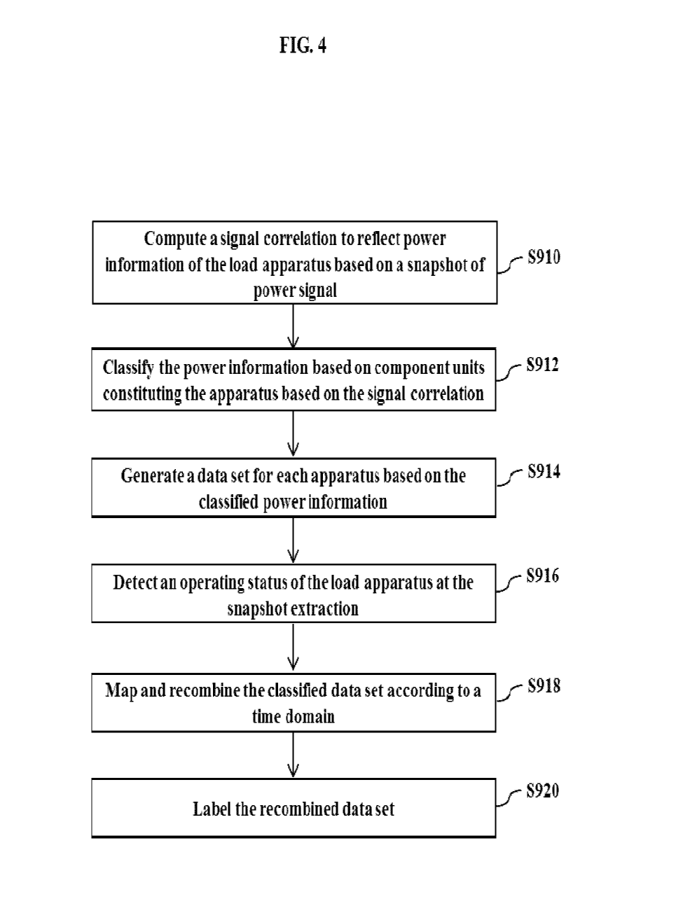

In an embodiment, the energy measuring apparatus 102, at the power penetration point, for load balancing between the energy measuring apparatus 102 and the server 700 is described. The power information collecting unit 702 is configured to collect power information at a snapshot extraction frequency. The snapshot extraction frequency described herein within a range of 9 to 999 per second. The operating status extracting unit 704 is configured to detect an operating status of at least one load apparatus at the snapshot extraction frequency. The operating status described herein is one of a steady state and a transient state. Further, the data set generating unit 706 is configured to generate a representative snapshot of the power information, when the normal status is detected. The data set generating unit 706 is configured to generate a plurality of snapshots of the power information, when the transient state is detected. Furthermore, the transmitting unit 708 is configured to transmit the representative snapshot of the power information, when the normal status is detected; and transmit all the snapshots of the power information, when the transient state is detected. Furthermore, the various operations performed for load management between the server 700 and the energy measuring apparatus 102 is described in conjunction with the FIGS. 3 and 4.

The FIG. 1 illustrates a limited overview of the energy measuring apparatus 102 but, it is to be understood that other embodiments are not limited thereto. The labels provided to each unit or component is only for illustrative purpose and does not limit the scope of the invention. Further, the one or more modules can be combined or separated to perform the similar or substantially similar functionalities without departing from the scope of the invention. Furthermore, the energy measuring apparatus 102 can include various other components interacting locally or remotely along with other hardware or software components to measure energy usage information of a plurality of load apparatus connected to a power penetration point. For example, the component can be, but is not limited to, a process running in the controller or processor, an object, an executable process, a thread of execution, a program, or a computer.

FIG. 2A is a flowchart illustrating various operations performed by the power information collecting unit 702 of the energy measuring apparatus 102 at a power penetration point, according to the embodiments as described herein. In the embodiment, the power information collecting unit 702 can be configured to measure a power signal (Step S802). Unprocessed power information waveforms of the current and the voltage are measured through the energy measuring apparatus 102 installed at the power penetration point and the single sensor.

Further, the power information collecting unit 702 can be configured to extract snapshot (Step S804). A voltage or current snapshot of an AC waveform having a predetermined cycle is collected. In the embodiment, snapshots of voltage having one AC cycle waveform and high-frequency current are preferably extracted.

FIG. 2B is a flowchart illustrating various operations performed by the operating status extracting unit 704 of the energy measuring apparatus 102 at a power penetration point, according to the embodiments as described herein. The operating status extracting unit 704 can be configured to distinguish between a normal or excessive status of a power change from the collected voltage or power information to extract an operating status or a change pattern of the operating status of the load apparatus.

Referring to the FIG. 2B, the operating status extracting unit 704 can be configured to extract power information and reference point (Step S806). In an embodiment, real-time power consumption and power quality information are extracted, and the reference point for distinguishing the normal or excessive status is extracted.

In the embodiment, the reference point is preferably power consumption which is constantly used without fluctuation while being not turned on or off and continuously turned on in each of the load apparatuses through the extraction of the real-time power consumption and power quality information.

Further, the operating status extracting unit 704 can be configured to separate an excessive response (Step S808). In an embodiment, an excessive status interval is extracted, in which turn-on or off is performed or the operating status is changed by operations of the individual load apparatuses in the power consumption.

Furthermore, in an embodiment, the operating status extracting unit 704 can be configured to remove a noise (Step S810). A meaningless high-frequency noise signal generated in power signal measurement of total power consumption is removed.

Furthermore, the operating status extracting unit 704 can be configured to classify the snapshot according to the extracted operating status or change pattern of the operating status. For example, in the case of being determined as the excessive response operation, the snapshot may have an even higher snapshot extraction frequency than the normal status.

Furthermore, the operating status extracting unit 704 can be configured to detect an on or off event (Step S812). In an embodiment, the snapshots for events are classified for each on or off status before clustering each of the individual load apparatuses through detection of the on or off event. The operating status extracting unit 704 can be configured to detect status change (Step S814). Multi-steps other than the on or off operation are provided. The change patterns of the operating statuses of loads which have a continuous change characteristic are detected and classified.

After detecting the status change, the operating status extracting unit 704 can be configured to process real-time total power consumption data (Step S816). In an embodiment, the power information data is operated and stored, and a transmission data packet is generated with respect to total energy consumption and the power quality information for a real-time power consumption service.

FIG. 2C is a flowchart illustrating various operations performed by the data set generating unit 706 of the energy measuring apparatus 102 at a power penetration point, according to the embodiments as described herein. The data set generating unit 706 can be configured to generate a data set for each of the individual load apparatuses which matches the operating status or the change pattern of the operating status through a signal correlation depending on power usage information of the individual load apparatuses.

Referring to the FIG. 2C, the data set generating unit 706 extracts load features (Step S820). In the embodiment, a signal correlation, on which the power usage features of the individual load apparatuses are reflected, is generated by using the snapshot, the excessive response, the on or off event, and the status change information extracted from the total power consumption data. The signal correlation can include the voltage or current correlation, the high-frequency distortion, the current or power signal deformation, the active or reactive power correlation, or the like.

Further, the data set generating unit 706 can be configured to match the on or off event (Step S822), and classify pattern matching load (Step S824) to generate the data set. The on or off operation events for the individual load apparatuses are classified in a pair of the same load apparatuses based on the generated signal correlation. The multi-steps or continuous change characteristics are classified into an association group with the on or off operation events with respect to the same load apparatus based on the generated signal correlation.

Furthermore, the data set generating unit 706 can be configured to generate a data set (Step S826). The data sets collected by the association group are generated through the on or off event matching and the pattern matching load classification.

When the data sets are generated, the transmitting unit 708 can be configured to transmit the generated data sets to the energy measurement information labeling server 700 that generates labeled power information by recombining the data sets.

Prior to the transmission, in the embodiment, the data packet generated by the energy measuring apparatus 102 is compressed to facilitate transmission of the massive data to the energy measurement information labeling server 700.

Further, the power consumption and the quality information data required to perform a real-time power energy information service can be together transmitted.

Further, referring to the FIGS. 2A to 2C, a snapshot extraction (that is, power signal sampling) period and the resulting information processing efficiency of the present invention will be described in detail.

In an embodiment, it is important for the power information collecting unit 702 to appropriately select the snapshot extraction frequency. When a snapshot extraction frequency is lower than a specific value, for example, when the snapshot extraction frequency is less than once per second, a resolution for a transient state interval of the load apparatus is low. As a result, it is difficult to distinguish different individual load apparatuses. When the snapshot extraction frequency is higher than a specific value, for example, when the snapshot extraction frequency is higher than thousands to ten thousand times per second, the resolution for the transient state interval is excessively high. As a result, an error may occur, such as recognizing the same load apparatuses as different load apparatuses. Therefore, the snapshot extraction frequency for efficient prior information processing of the energy measuring apparatus at the penetration point of power is appropriately 9 to 999 times per second.

Further, information processing after extracting the operating state may be efficient through the snapshot classification of the operating status extracting unit 704 (e.g., a method in which, in the snapshot extraction step (S804), the snapshot is continuously extracted at 15 times per second. But when there is no change in operating status, only one snapshot among 15 snapshots or 15 representative values are selected and classified. When the change in operating status is sensed, all of the 15 snapshots are selected to separately increase only the resolution of the transient state interval). That is, by a method in which while the resolution of the transient state interval (which is required for the energy usage information analysis) for each apparatus increases, a data traffic related burden decreases (e.g., even in the case where the transmitting unit 708 periodically transmits data once per second, when there is no change in operating status, only one snapshot which is selected and classified, or the representative value calculated through mensuration of division is transmitted. During the transient state interval, 15 snapshots are transmitted at once). Whole system's capability of load balancing between the energy measuring apparatus 102 and the server 700 is improved. As a result, the on or off event detecting step (S812), the stats change detecting step (S814), and some or all the steps performed by the data set generating unit 706 may be performed through the server 700.

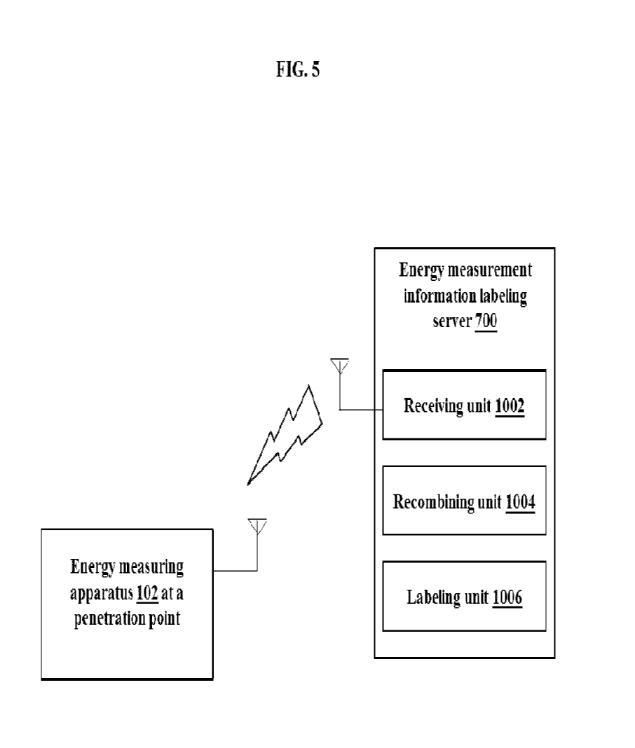

The details of the energy measurement information labeling server 700 that generates the labeled power information by receiving the data sets generated by the power penetration point energy measuring apparatus 102 are described in conjunction with the FIG. 5.

The various actions, acts, blocks, steps, or the like of the FIG. 2 may be performed in the order presented, in a different order or simultaneously. Further, in some embodiments, some of the actions, acts, blocks, steps, or the like may be omitted, added, modified, skipped, or the like without departing from scope of the invention.

FIG. 3 is a flow chart illustrating various operations performed by the energy measuring apparatus 102 for load management between the energy measuring apparatus 102 and the server 700, according to an embodiment as disclosed herein. At S902, the method includes collecting power information at a snapshot extraction frequency, wherein the snapshot extraction frequency is within a range. In an embodiment, the range described herein is within 9 to 999 times per second. Unlike the conventional systems and methods, an appropriate snapshot extraction frequency selected for the efficient prior information processing of the energy measuring apparatus at the penetration point of power. For example, when the snapshot extraction frequency is lower than a specific value, for example, when the snapshot extraction frequency is less than once per second, a resolution for a transient state interval of the load apparatus is low. As a result, it is difficult to distinguish different individual load apparatuses. When the snapshot extraction frequency is higher than a specific value, for example, when the snapshot extraction frequency is higher than thousands to ten thousand times per second, the resolution for the transient state interval is excessively high. As a result, an error may occur, such as recognizing the same load apparatuses as different load apparatuses. Therefore, the snapshot extraction frequency for efficient prior information processing of the energy measuring apparatus at the penetration point of power is appropriately 9 to 999 times per second.

At S904, the method includes detecting an operating status of load apparatus at the snapshot extraction frequency. In an embodiment, the operating status described herein is one of a steady state and a transient state. At S906, the method includes generating a data set including a representative snapshot of the power information, when the normal status is detected; and generating a data set including a plurality of snapshots of the power information, when the transient state is detected as shown at S908. For example, the snapshot is continuously extracted at 15 times per second. But when there is no change in operating status, only one snapshot among 15 snapshots or 15 representative values are selected and classified. When the change in operating status is sensed, all of the 15 snapshots are selected to separately increase only the resolution of the transient state interval). Unlike the conventional systems and methods, the snapshot is selected based on a mensuration method. That is, by a method in which while the resolution of the transient state interval (which is required for the energy usage information analysis) for each apparatus increases, a data traffic related burden decreases (e.g., even in the case where the transmitting unit 708 periodically transmits data once per second, when there is no change in operating status, only one snapshot which is selected and classified, or only one representative value calculated through mensuration of division is transmitted. During the transient state interval, 15 snapshots are transmitted at once). Whole system's capability of load balancing between the energy measuring apparatus 102 and the server 700 is improved. As a result, the on or off event detecting step (S812), the stats change detecting step (S814), and some or all the steps performed by the data set generating unit 706 may be performed through the server 700 as described in the FIG. 4.

FIG. 4 is a flow chart illustrating various operations performed by the server 700 for load management between the energy measuring apparatus 102 and the server 700, according to an embodiment as disclosed herein. At S910, the method includes computing a signal correlation to reflect power information of the load apparatus based on a snapshot of power signal. In an embodiment, the method allows the server 700 to compute the signal correlation to reflect power information of the load apparatus based on the snapshot of the power signal. The signal correlation described herein includes at least one of voltage correlation, current correlation, high-frequency distortion, power signal deformation, active power correlation, and reactive power correlation. The snapshot of the power signal described herein is related to one of a voltage snapshot and a current snapshot of a waveform having a predetermined cycle measured at a distant energy measuring apparatus.

At S912, the method includes classifying the power information based on component units constituting the apparatus based on the signal correlation. In an embodiment, the method allows the server 700 to match the on or off event and classify pattern matching load to generate the data set. The on or off operation events for the individual load apparatuses are classified in a pair of the same load apparatuses based on the generated signal correlation. The multi-steps or continuous change operation are classified into an association group with the on operation or off operation events with respect to the same load apparatus based on the generated signal correlation.

At S914, the method includes generating a data set for each apparatus based on the classified power information. In an embodiment, the data sets collected by the association group are generated through the on or off event matching and the pattern matching load classification.

At S916, the method includes detecting an operating status of the load apparatus at the snapshot extraction. The method allows the server 700 detect the operating status of the load apparatus at the snapshot extraction. A distribution plane is distinguished according to load operating characteristics (on or off, multi-steps, a continuous change, always activation, or the like) for the individual load apparatuses determined as the same energy load apparatus.

At S918, the method includes mapping and recombining the classified data set according to a time domain. In an embodiment, the method allows the server 700 to map and recombine the classified data set according to the time domain. At S920, the method includes labeling the recombined data sets.

The various actions, acts, blocks, steps, or the like of the FIGS. 3 and 4 may be performed in the order presented, in a different order or simultaneously. Further, in some embodiments, some of the actions, acts, blocks, steps, or the like may be omitted, added, modified, skipped, or the like without departing from scope of the invention.

FIG. 5 is a block diagram illustrating the energy measurement information labeling server 700, according to the embodiments as described herein. In an embodiment, the energy measurement information labeling server 700 can be configured to process the energy usage information and saving tip consulting for a power user at the power penetration point through processes such as machine running and automatic labeling based on the received clustering data set and real-time power consumption, and power quality information data set. The energy measurement information labeling server 700 may be a mass data processing device that processes the total energy information and energy information for each of the individual load apparatuses to generate various energy saving solutions.

In an embodiment, the energy measurement information labeling server 700 can be configured to process specific post information through the various computer operations. The process reclassifies the unregistered load clustering data set into multi-dimensional planes based on the reference area, such as the active power, the reactive power, the time, or the like. The process sets a classification boundary surface in the same load apparatus through the machine running to distinguish the unregistered load clustering set for each specific operation or component such as on or off, multi-steps, continuous change, always-activation, or the like.

The distinguished data sets are mapped to the real-time power consumption change to complete the distinguishment and the lower components of the individual load apparatuses are grouped into the same load apparatus which may be recognized by the user (1+2+3 or A+B+C). Further, the registered data sets (refrigerator, washing machine, air-conditioner, or the like) of the individual load apparatuses are matched which have been already stored to be automatically labeled.

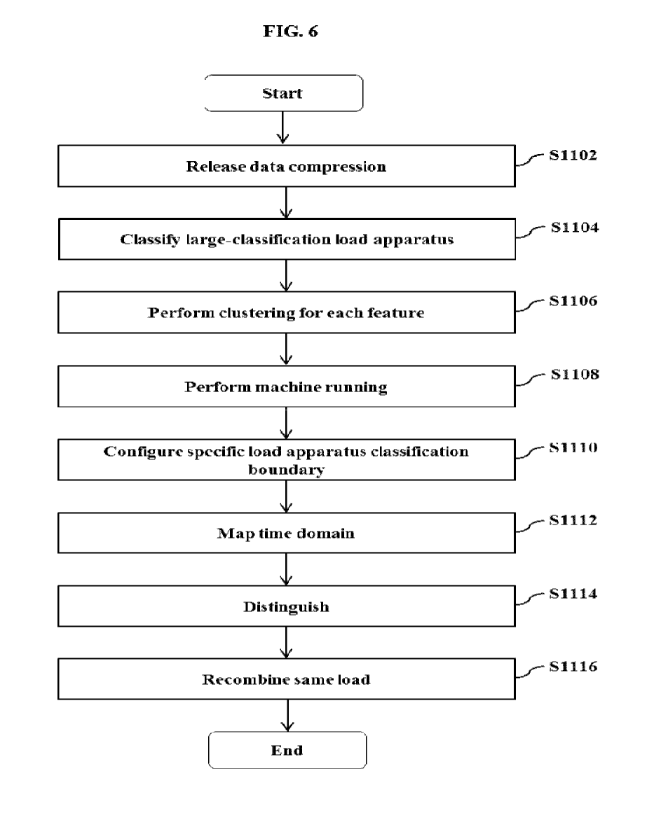

In this case, the load apparatuses which are not automatically labeled due to data which are present in the registered data sets are manually labeled through a means of checking the corresponding time by manually turning on or off the load apparatuses which are not automatically labeled. In addition, the manually generated data are added to the pre-collected data set again and then used for the automatic labeling. Further, the various components of the energy measurement information labeling server 700 and operations thereof are described in conjunction with FIG. 6.

Referring to FIG. 5, in an embodiment, the energy measurement information labeling server 700 can include a receiving unit 1002, a recombining unit 1004, and a labeling unit 1006.

The receiving unit 1002 can be configured to receive a data set generated by classifying power information based on individual load apparatuses. The recombining unit 1004 can be configured to reclassify the received data set on a multidimensional plane according to operating characteristics of the individual load apparatuses. Further, the recombining unit 1004 can be configured to map and recombine the classified data set according to a time domain.

Prior to this, the recombining unit 1004 can be configured to decompress data. When the energy measuring apparatus 102 transmits the compressed data, the energy measuring apparatus 102 can cancel the data compression in order to increase the execution speed. When the compression is cancelled, the recombining unit 1004 can be configured to map the reclassified data to a power consumption change in the time domain to recombine components in the same load apparatus.

The FIG. 5 illustrates a limited overview of the energy measurement information labeling server 700 but, it is to be understood that other embodiments are not limited thereto. The labels provided to each unit or component is only for illustrative purpose and does not limit the scope of the invention. Further, the one or more components can be combined or separated to perform the similar or substantially similar functionalities without departing from the scope of the invention. Furthermore, the energy measurement information labeling server 700 can include various other components interacting locally or remotely along with other hardware or software components to label the extracted energy usage information of a plurality of load apparatus connected to a power penetration point. For example, the component can be, but is not limited to, a process running in the controller or processor, an object, an executable process, a thread of execution, a program, or a computer.

FIG. 6 is a flowchart illustrating various operations performed by the energy measurement information labeling server 700, according to the embodiments as described herein. In an embodiment, the recombining unit 1004 can be configured to decompress data (Step S1102). When the energy measuring apparatus 102 transmits the compressed data, the energy measuring apparatus 102 can cancel the data compression in order to increase the execution speed. The recombining unit 1004 can be configured to classify large classification load apparatus (Step S1104). A distribution plane is distinguished according to load operating characteristics (on or off, multi-steps, a continuous change, and always activation) for the individual load apparatuses determined as the same energy load apparatus.

Further, the recombining unit 1004 can be configured to perform clustering of features (Step S1106). The multi-dimensional plane is reconfigured so as to facilitate setting a boundary in the distribution plane by interlocking a clustering data set. In an embodiment, the active power, the reactive power, a time, or the like can be reference areas in reconfiguring the multi-dimensional plane.

When the multi-dimensional plane is reconfigured, the recombining unit 1004 can be configured to perform machine learning (Step S1108). The operations of the individual load apparatuses or an inter-component boundary classification reference is generated by using a clustering result for each load apparatus and a machine running method based on a status distinguishment technique such as an artificial intelligence network. In addition, the recombining unit 1004 can be configured to set specific load apparatus classification boundary (Step S1110). Data are reclassified by performing load distinguishment at an individual component level for clustering data by using the machine running boundary classification reference. In this case, unregistered-scheme detailed load classification is determined up to component levels for the individual load apparatuses from a total electric energy.

Further, the recombining unit 1004 can be configured to map time domain (Step S1112). The data sets for unregistered components reclassified in the process are mapped to real-time data in the time domain. The recombining unit 1004 can be configured to distinguish the mapped data (Step S1114). The mapped data are distinguished at the component level by various colors or a display method which may be recognized by the user.

Furthermore, the recombining unit 1004 can be configured to recombine the same load (Step S1116). A group is generated for the load apparatus which may be recognized by the user by combining sub components in the individual load apparatuses generated in the distinguishing step. As one example, compressor, motor, lamp, and control circuit characteristics, generated in the distinguishing step, are combined to be grouped into a refrigerator.

After the recombination step, the labeling unit 1006 can be configured to label the recombined data set. For example, a name of a corresponding load apparatus automatically matches unregistered temporary mark data classified as the individual load apparatuses in association with a prestored load apparatus data set. As one example, the A, B, C, or the like may be automatically registered as a refrigerator, a television, a washing machine, or the like through a data pattern and a matching technique with storage data.

Further, in the embodiment, labeling may be manually received. In spite of execution of automatic labeling, a developer or the user manually names apparatuses with respect to loads which are unregistered due to mismatching with prestored load apparatus data and inputs the names. A method that uses an on or off time of the apparatus is also available.

Further, the corresponding data are separately stored together with registration with respect to the individual load apparatuses in which the manual labeling is performed to extend a prestored load apparatus data set.

Furthermore, the energy measurement information labeling server 700 may provide data analysis information using energy usage information of the individual load apparatuses. The data analysis based on a behavioristic psychology analysis technique may be applied to total power and energy usage patterns of the individual load apparatuses to generate a specific data set.

Further, a specialist consulting tip to induce energy saving of the user may be automatically generated through the data analysis.

Moreover, an integrated service is available, which provides the total electric energy, usages of the individual load apparatuses, energy saving consulting, or the like to a specific building and a unit household through an energy IT special provider.

Example of various energy saving consulting can be, when a change of the clustering data set distinguished at the component level is sensed in association with the statuses of the individual load apparatuses to determine component aging statuses or failure statuses of the individual load apparatuses, to provide the determined component aging statuses or failure statuses to the user.

According to the embodiments, the hardware of the meter and the software techniques on the server are combined to extract energy usage information about individual components of various load apparatuses from total energy usage information at the power penetration point.

Further, since the software technique of the server is flexibly combined with the single energy measuring apparatus, detailed and accurate energy usage information of the individual load apparatuses is extracted without large cost for system installation through multiple apparatuses to derive a high-end energy saving scheme. In particular, it is possible to acquire energy usage information higher than a branch circuit level without adopting multiple sensors in the distribution board.

In summary, in the present invention, in extracting the energy usage information of the individual load apparatuses in the total electric energy consumption measured at the power penetration point, a specific server does not perform all techniques. Unlike the conventional mechanisms, the previous information processing is performed so as to have resolution which may be distinguished for each component in the single energy measuring apparatus and the server concentratively performs data storage, pattern analysis, and data utilization as an advantage thereof to secure flexibility in energy usage associated mass data processing, storing, or management of various loads.

The various actions, acts, blocks, steps, or the like of the FIG. 6 may be performed in the order presented, in a different order or simultaneously. Further, in some embodiments, some of the actions, acts, blocks, steps, or the like may be omitted, added, modified, skipped, or the like without departing from the scope of the invention.

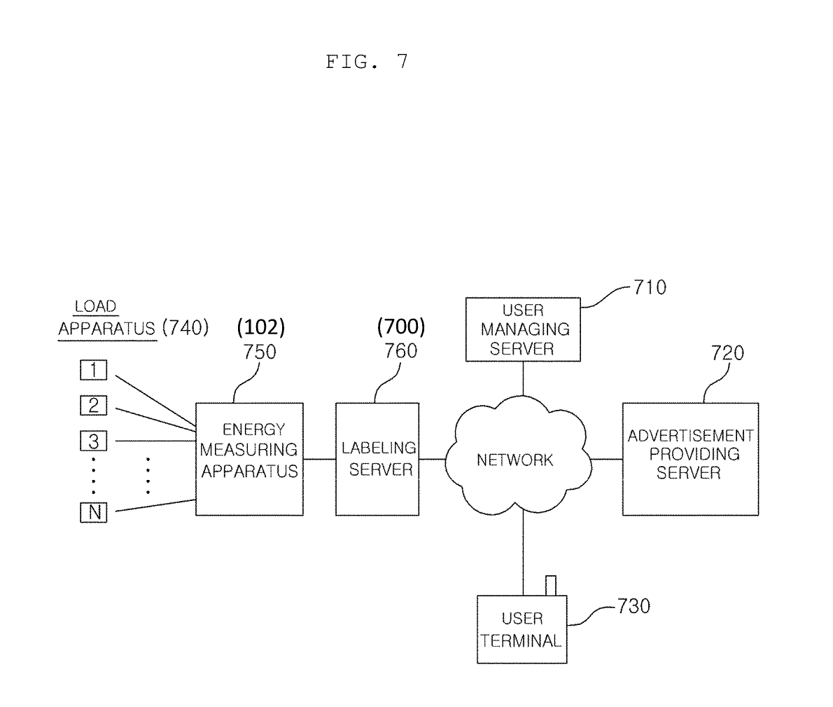

Hereinafter, a user customized advertisement providing technique based on a user profile in accordance with information on user identification and information on a user's power consumption pattern will be described with reference to FIGS. 7 to 11. An energy measuring apparatus which will be mentioned below is the same as the energy measuring apparatus 102 of FIG. 1 so that the detailed description thereof will be omitted.

A labeling server which will be mentioned below is the same as the labeling server 700 of FIG. 1 so that detailed description thereof will be omitted. However, due to an integrated configuration of the labeling server and a user managing server which will be described below, it will be separately described below that a labeling server performs a user profile generation related function or a user management server performs a labeling related function.

FIG. 7 illustrates a view of a configuration of a system (hereinafter, referred to as a customized advertisement system) which provides a user customized advertisement according to an exemplary embodiment of the present invention.

Referring to FIG. 7, a customized advertisement system includes a user managing server 710 which generates a user profile based on first user information on user identification and second user information by a power consumption pattern, an advertisement providing server 720 which selects a user customized advertisement based on the generated user profile, and a user terminal 730 which receives and outputs a user customized advertisement selected from the advertisement providing server 720.

Here, the first user information is information for identifying a user and may include at least one of a name, an ID, a gender, an address, a load apparatus identification information, and favorite information. For example, the ID may refer to an ID which is registered in a user customized advertising service or a power managing service (corresponds to a power managing function described with reference to FIGS. 1 to 6). The load apparatus identification information may refer to identification information (for example, an apparatus name, a serial number, and an identification number) of load apparatus which is possessed by a user (or an ID), that is, the load apparatus registered for the user customized advertising service or a power managing service. The favorite information may include an interest area of the user, a favorite/nonfavorite product group, an advertisement providing favorite/nonfavorite time zone, and a favorite/nonfavorite advertisement group. The favorite information may be directly input by the user or automatically input in consideration of a product purchasing history through advertisement or advertisement watching time.

Here, the second user information is information on power consumption of a user for every load apparatus and may include at least one of power information at every time zone, status information, and frequency information. For example, the power information at every time zone may include power used by load apparatus at every time zone, and information on a time zone when power consumption is high or low, and information on a time zone when change of power consumption is large or small. The status information is information on a status of load apparatus based on a power used by the load apparatus. For example, in case of a refrigerator, the status information may include information on an on/off status, a continuous operating time of a freezer, and an on/off status of a defroster. In case of an air conditioner, the status information may include information on an on/off status, a continuous operating time, and an outdoor temperature at the time of operating the air conditioner. Further, in case of a washing machine, the status information may include information on an on/off status, an operating time, and a washing type (for example, dewatering, rinsing, sterilizing, and drying). The frequency information may refer to information on how often or how frequently the home appliances are used at a specific time zone by using the on/off and status information of the individual appliance at a specific time zone.

Here, the user profile may include at least one of the user's behavior and the user's tendency which is predicted based on the first and second user information. For example, when the air conditioner is operated by the user X (female) and the outside temperature at that time is relatively lower than other people, it is predicted that the tendency of the user X is sensitive to temperature. When a usage interval of the washer of a user X (female) is relatively short, it is predicted that the tendency of the user X is sensitive to cleanliness. When a lamp usage amount is high between 9 and 12 for the user X (address: ** university) and an electric usage amount of entertainment apparatus such as TV is low, it may be predicted that the behavior of the user X mainly reads books at night. At night, when a power usage amount of cooking apparatus such as a microwave of a user X (male) is increased at night time or an operation maintaining time of a freezer of the refrigerator is lengthened, it is predicted that the user X eats a late night snack.

The user managing server 710 transmits some information required to select a user customize advertisement among the generated user profiles and the advertisement providing server 720 selects the user customized advertisement based on some information. For example, when some information is load apparatus identification information_lamp 1 (or air conditioner), status information_maintained to be turned on for a predetermined time or longer of one day, it is determined that a high efficiency lamp (or buying a high efficiency air conditioner) needs to be bought. Therefore, a high efficiency lamp related advertisement (or air conditioner related advertisement) is selected as a user customized advertisement by being compared with an electricity usage amount of the currently used apparatus.

The user managing server 710 predicts a user's demand based on at least one of the user's behavior and the user's tendency predicted above and transmits the predicted user's demand to the advertisement providing server 720. In this case, the advertisement providing server 720 may select the user customized advertisement in consideration of the predicted user's demand. For example, when the user's tendency is sensitive to the temperature, a demand to buy an air conditioning and heating apparatus, a demand to buy seasonal clothes, or a demand to visit seasonal tourist spots may be predicted and an advertisement related to the air conditioning and heating apparatus, the seasonal clothes, or a travel agency is selected as the user customized advertisement. When the user's tendency is sensitive to the cleanliness, a demand to buy cleaning supplies/sanitizing supplies or to request a cleaning agency service is predicted and the cleaning supplies/sanitizing supplies related advertisement and the cleaning service agency related advertisement may be selected as the user customized advertisement. When a user's behavior is reading a book, a demand to buy a new book, buy a best seller book, buy a book in an interested field, and buy a work-related book may be predicted and the book related advertisement may be selected as the user customized advertisement. When the user's behavior is eating a late night snack, a demand for a late night snack delivery, recommended late night snack information, and nearby restaurant with great tasting food information is predicted and a late night snack delivery restaurant related advertisement is selected as the user customized advertisement.

The user managing server 710 collects the current status information of the user to transmit the information to the advertisement providing server 720. In this case, the advertisement providing server 720 may select the user customized advertisement in consideration of the current status information of the user.

For example, the current status information of the user may include current location information of the user, current body temperature information, and current weight information. Further, the current status information may include current temperature/time/weather information. Therefore, when the current location of the user whose demand is to buy cleaning supplies/air conditioning and heating apparatus is a mart/department, the advertisement providing server 720, the advertisement providing server 720 may select the cleaning supplies/air conditioning and heating apparatus related advertisement as a user customized advertisement. Alternatively, when a current weight of a user whose demand is to deliver a late night snack is overweight, the advertisement providing server 720 may select an advertisement of a low calorie late night snack delivery restaurant as the user customized advertisement.

Moreover, the system for providing a user customized advertisement may further include an energy measuring apparatus 750 which obtains a data set for the power consumption in accordance with an operation status of each load apparatus 740 of the user or a changing pattern of the operation status and a labeling server 760 which labels the data set received from the energy measuring apparatus 750. In this case, the user managing server 710 receives the data set labeled from the labeling server 760 and obtains second user information from the received labeled data set.

Further, security communication may be performed among the user managing server 710, the advertisement providing server 720, the user terminal 730, the energy measuring apparatus 750, and the labeling server 760. The user power consumption, the user profile, and the user customized advertisement transmitted and received between components of the customized advertisement system are information on user's privacy so that information security is necessary and security communication may be requested. However, a security communication scheme is not specifically limited and a security communication scheme according to the related art may be applied.

For example, when information transmission of a user profile between the use management server 710 and the advertisement providing server 720 is assumed, the user management server 710 transmits the information by encrypting the information with a specific key and the advertisement providing server 720 may decode the encrypted information using the specific key. In this case, the specific key may refer to an inherent key shared only between the user management server 710 and the advertisement providing server 720.

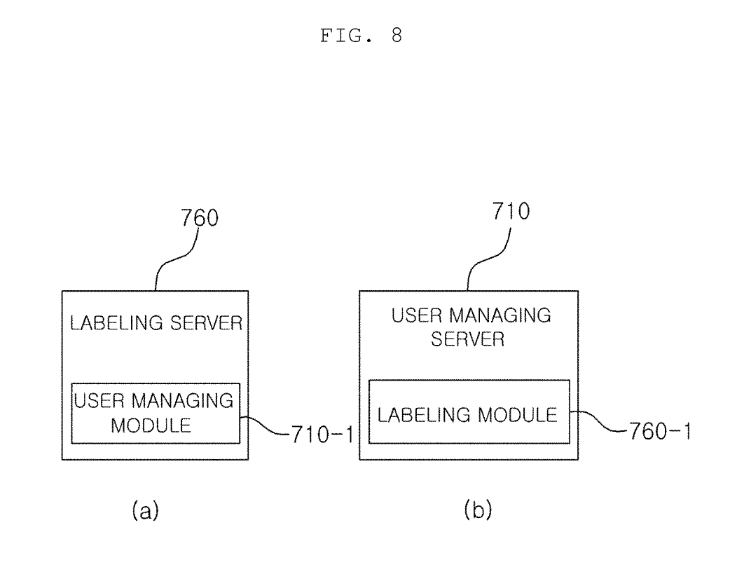

FIG. 8 illustrates a view of a configuration of a server in which the labeling server 760 and the user managing server 710 of FIG. 7 are combined according to an exemplary embodiment of the present invention. FIGS. 8A and 8B explain depending on whether a main agent of the combination is the labeling server 760 or the user managing server 710. However, one combined server performs functions as both the user managing server 710 and the labeling server 760 so that the functions and the characteristics thoseof are not different from each other.

Referring to FIG. 8A, the labeling server 760 may include a user managing module 710-1 which performs a function as the user managing server 710. In this case, the customized advertisement system may not separately configure the user managing server 710.

Referring to FIG. 8B, the user managing server 710 may include a labeling module 760-1 which performs a function as the labeling server 760. In this case, the customized advertisement system may not separately configure the labeling server 760.

Specifically, in FIG. 8B, the user managing server 710 labels the data set received from the energy measuring apparatus 750 using the labeling module 760-1 and obtains second user information from the labeled data set.

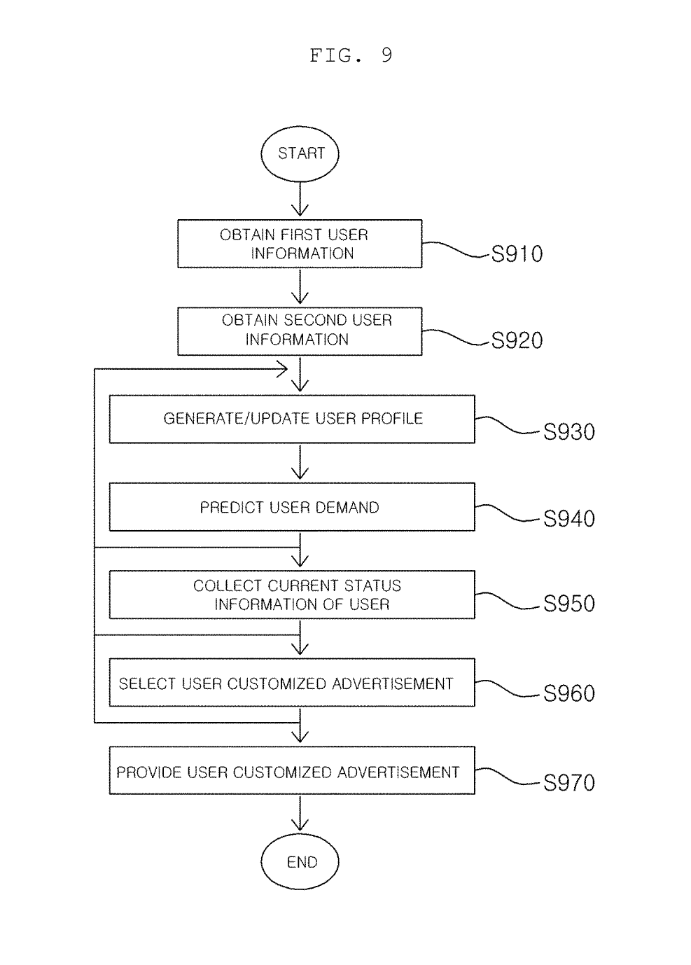

FIG. 9 illustrates a flowchart of a method for providing a user customized advertisement according to an exemplary embodiment of the present invention. For the convenience of description, the system of FIGS. 7 and 8 is referred to.

Referring to FIG. 9, the user managing server 710 obtains first user information on user identification in step S910 and obtains second user information on a power consumption pattern in step S920. Steps S910 and S920 for obtaining the first and second user information are not limited to the order of the steps and may be performed in any step on the flowchart.

In the obtaining step S910, the user managing server 710 may directly receive the first user information from the user through the user terminal 730 or extract the first user information from information input when the customized advertisement service or the power management service is registered.

In the obtaining step S920, the user managing server 710 may collect a data set for the operation status of the load apparatus 740 of the user or power consumption in accordance with the changing pattern of the operation status using the energy measuring apparatus 750, label the collected data set, and obtain the second user information from the labeled data set. Referring to FIG. 8B, the user managing server 710 may collect and label the data set using the labeling module 760-1. Moreover, referring to FIG. 7, the labeling server 760 collects and labels the data set and the user managing server 710 receives the labeled data from the labeling server 760 and obtains the second user information therefrom.

The user managing server 710 generates the user profile based on the obtained first and second user information in step S930. The user managing server 710 may store the generated user profile. Information in a specific data field may be permanently stored or stored only for a predetermined period.

Moreover, in the generating step S930, the user managing server 710 predicts at least one of the user's behavior and the user's tendency based on the obtained first and second user information and reflects at least one of the predicted user's behavior and user's tendency to the user profile.

Here, the user profile may include the first and second user information and include a plurality of data fields corresponding to the user's behavior or the user's tendency predicted therefrom. For example, the data field may include a user name/ID field, a user's gender field, load apparatus identification information, a power consumption pattern field for every load apparatus, a usage frequency field for every load apparatus, a user's behavior field, and a user's tendency field. Moreover, the data field may include a field corresponding to the user's demand predicted from the user's behavior or the user's tendency. For example, the user profile may be generated for every user or every load apparatus of the user or a plurality of user profiles may be generated for one user.

The user managing server 710 predicts the user's demand based on at least one of the user's behavior and the user's tendency predicted in the generating step S930 in step S940. The above description will be referred therefor.

The user managing server 710 collects current status information of the user in step S950.

For example, the user managing server 710 collects current location information, current weight information, and current body temperature information of the user from the user terminal 730 to collect the current status information of the user.

The advertisement providing server 720 selects a user customized advertisement based on the user profile generated in the generating step S930 in step S960. Moreover, the advertisement providing server 720 may select the user customized advertisement in consideration of the user's demand or the user's current status provided from the user managing server 710.

For example, the advertisement providing server 720 is provided with the user's profile from the user managing server 710 using a security communication scheme or provided only with information (for example, the user, the gender, the favorite information, the user's behavior, and the user's tendency) required to select the user customized advertisement among the user's profile.

For example, when the user's demand is “late night snack delivery” and information required to select a user customized advertisement is “favorite food_chicken and favorite time_ten at night”, the advertisement providing server 720 may select an advertisement of a chicken delivery store at 10 pm at night to provide the advertisement to the user terminal 730.

For example, when the user's demand is “to buy air conditioning and heating apparatus” and the current status information of the user is “** department”, and the user profile is “marriage status_single, and residence pattern_small size apartment”, the advertisement providing server 720 selects an advertisement of an air conditioner model suitable for a small area among air conditioners which are being sold in the department store to provide the advertisement to the user terminal 730.

The advertisement providing server 720 provides the user customized advertisement selected in the selecting step S960 to the user terminal 730 in step S970. Therefore, the user terminal 730 receives and outputs the user customized advertisement. In the meantime, the selected user customized advertisement may be provided to the user terminal 730 using a security communication scheme.

The user managing server 710 returns to the generating step S930 to update the user profile.

In the updating step S930, the user managing server 710 may reflect the user's demand, the current status information of the user or the user customized advertisement selected in the selecting step S960 to update the user profile. The user profile may also be directly updated by the user or periodically updated by the user managing server 710.

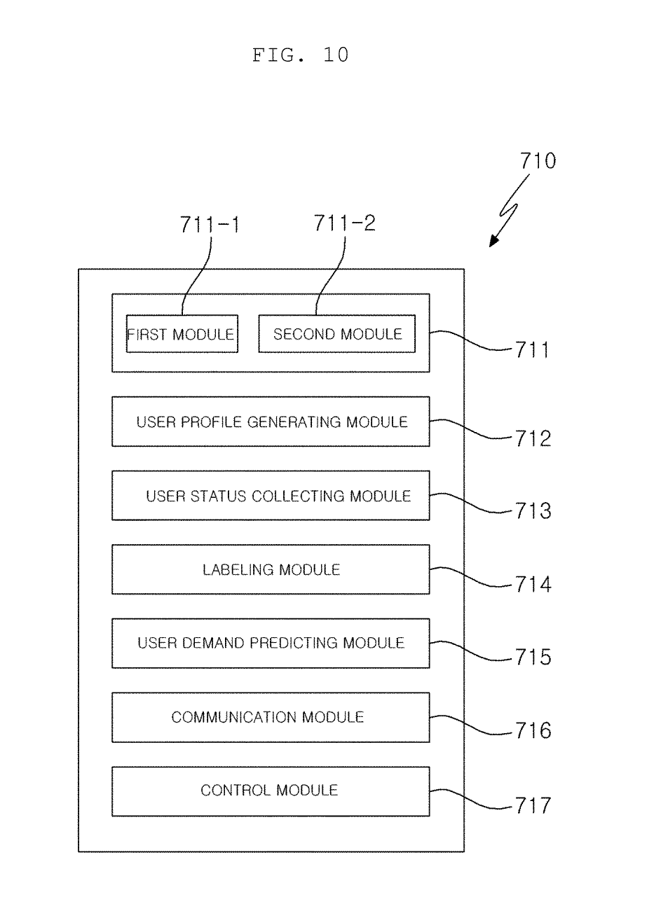

FIG. 10 illustrates a view of a configuration of a user managing server for providing a user customized advertisement according to an exemplary embodiment of the present invention.

Referring to FIG. 10, the user managing server 710 includes a user information managing module 711 which obtains and manages first user information on user identification and second user information on a power consumption pattern, a user profile generating module 712 which generates a user profile based on the first and second user information, a communication module 716 which transmits predetermined information required to select the user customized advertisement based on the user profile to the advertisement providing server, and a control module 717 which controls an operation of at least one of the user information managing module 711, the user profile generating module 712, and the communication module 716. Here, the communication module 716 may perform security communication with at least one of the advertisement providing server, the energy measuring apparatus, the labeling server, and the user terminal.

Moreover, the user information managing module 711 may include a first user information managing module 711-1 which obtains and manages the first user information including at least one of a name, an ID, a gender, an address, load apparatus identification information, and favorite information and a second user information managing module 711-2 which obtains and manages the second user information including at least one of power information at every time zone, status information, and frequency information as information on power consumption for every load apparatus of the user.

More specifically, the first and second user information managing modules 711-1 and 711-2 may store and update the first and second user information in accordance with the control of the control module 717. The obtaining of the first and second user information will be described with reference to the description of the obtaining steps S910 and S920 of FIG. 9.

Specifically, when the labeling server is separately provided (see FIG. 7), the communication module 716 receives a data set matching the operation status of the load apparatus of the user or a changing pattern of the operation status from the labeling server and the second user information managing module 711-2 obtains the second user information from the received data set.

In the meantime, even when the labeling server and the user management server are combined (see FIG. 8B), the user managing server 710 may further include a labeling module 714 which labels a data set matching the operation state of the load apparatus of the user or the changing pattern of the operation status. The second user information managing module 711-2 may obtain the second user information from the labeled data set.

The user profile generating module 712 extracts the information required to generate the user profile between the first and second user information from the first and second user information managing modules 711-1 and 711-2 and combines the extracted information to generate the user profile. Moreover, the user profile generating module 712 may update the data field of the user profile when the first and second user information is updated.

Further, the user profile generating module 712 predicts at least one of the user's behavior and the user's tendency based on the first and second user information and reflects at least one of the predicted user's behavior and user's tendency to the user profile.

For example, the user profile generating module 712 extracts and combines “name_Kim ** and gender_female” from the first user information and “a predetermined number or more of usage of cooking electronic appliances such as a microwave between 9 to 12 at night” from the second user information and predicts “eating of a late night snack at a night time zone” as a user's behavior based on the combined user information and reflects the combined user information and the predicted user's behavior to generate or update the user profile.

For example, the user profile generating module 712 extracts and combines “name_Kim ** and address_Yeoksam-dong, Gangnam-gu, Seoul” from the first user information and “a predetermined time or longer of using an air conditioner at 1 to 3 in the afternoon for a predetermined period” from the second user information, predicts that the user's tendency is “sensitive to the temperature in the afternoon” based on the combined user information and reflects the combined user information and the predicted user's behavior to generate or update the user profile.

The user management server 710 may further include a user demand predicting module 715 which predicts the user's demand based on at least one of the predicted user's behavior and user's tendency in accordance with the control of the control module 717. The communication module 716 may transmit the predicted user's demand to the advertisement providing server so that the predicted user's demand is considered to select the user customized advertisement.

For example, when the user's tendency is sensitive to the temperature, a demand to buy an air conditioner and heating apparatus, buy seasonal clothes, and visit seasonal tourist spots may be predicted. When the user's tendency is sensitive to the cleanliness, a demand to buy cleaning supplies/sanitizing supplies or request a cleaning agency service may be predicted. When the user's behavior is reading a book, a demand to buy a new book, buy a best seller book, buy a book in an interested field, and buy books in a work-related field may be predicted. When the user's behavior is eating a late night snack, a demand for delivering a late night snack, recommended late night snack information, and nearby restaurant with great tasting food information may be predicted.

Further, the user managing server 710 may further include a user status collecting module 713 which collects the current status information of the user in accordance with the control of the control module 717. The communication module 716 may transmit the collected user's current status information to the advertisement providing server so that the collected user's current status information is considered to select the user customized advertisement.

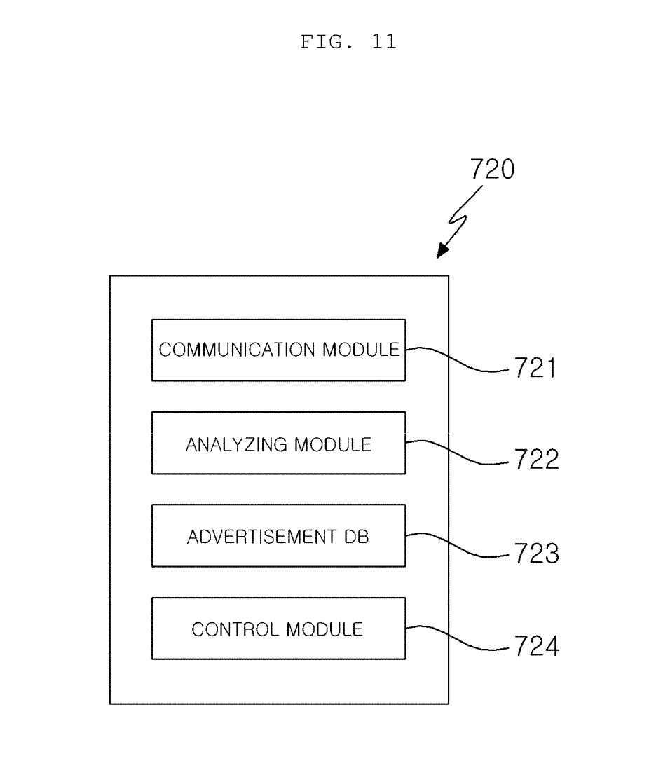

FIG. 11 illustrates a view of a configuration of an advertisement providing server for providing a user customized advertisement according to an exemplary embodiment of the present invention.

Referring to FIG. 11, the advertisement providing server 720 may include a communication module 721 which communicates with an external server/terminal such as the user managing server 710 or the user terminal 730, an analyzing module 722 which analyzes the user profile (or some information required to select the user customized advertisement of the user profile), the user's demand, or current status information of the user which are received through the communication module 721 to select a user customized advertisement, an advertisement database 723 which stores the advertisement, and a control module 724 which controls operations of the communication module 721, the analyzing module 722, and the advertisement database 723.

The communication module 721 may receive the user profile (or some information required to select the user customized advertisement of the user profile), the user's demand, or the current status information of the user from the user managing server 710. Further, the communication module 721 may transmit the user customized advertisement selected by the analyzing module 722 to the user terminal. In this case, the security communication scheme may be applied among the user managing server, the advertisement providing server, and the user terminal.

The analyzing module 722 analyzes the received user profile (or some information required to select the user customized advertisement of the user profile), the user's demand, or current status information of the user and selects the user customized advertisement corresponding to the analysis result to search from the advertisement database 723.

For example, when a current location of a user whose demand is “to buy cleaning supplies/buy an air conditioner and heating product” is “mart/department store” and the user profile is “favorite information_**electronic product”, the analyzing module 722 may select an advertisement related with the cleaning supplies/air conditioning and heating product manufactured/sold from **electronics as a user customized advertisement. Alternatively, when the user's demand is “late night snack delivery”, the current weight of the user is “overweight” and the user profile is “address_Yeoksam-dong, and favorite food_chicken”, the analyzing module 722 may select an advertisement of a low calorie chicken delivery restaurant near Yeoksam-dong as the user customized advertisement. Alternatively, when the user's demand is “to buy a new book” and the user profile is “favorite genre_comedy”, the analyzing module 722 may select an advertisement related with a new book in a comedy genre as a user customized advertisement.

The advertisement database 723 may store a plurality of advertisement contents provided from at least one advertising company or at least one product/service providing company.

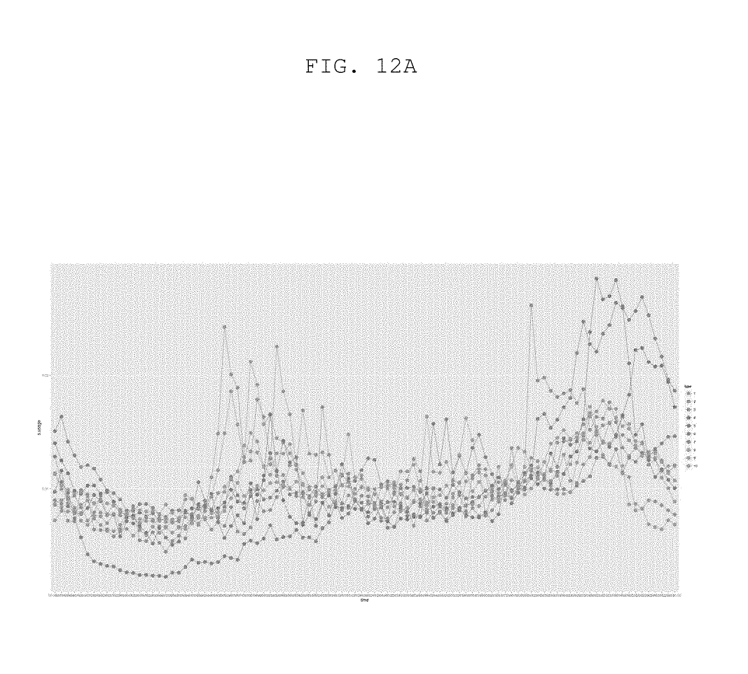

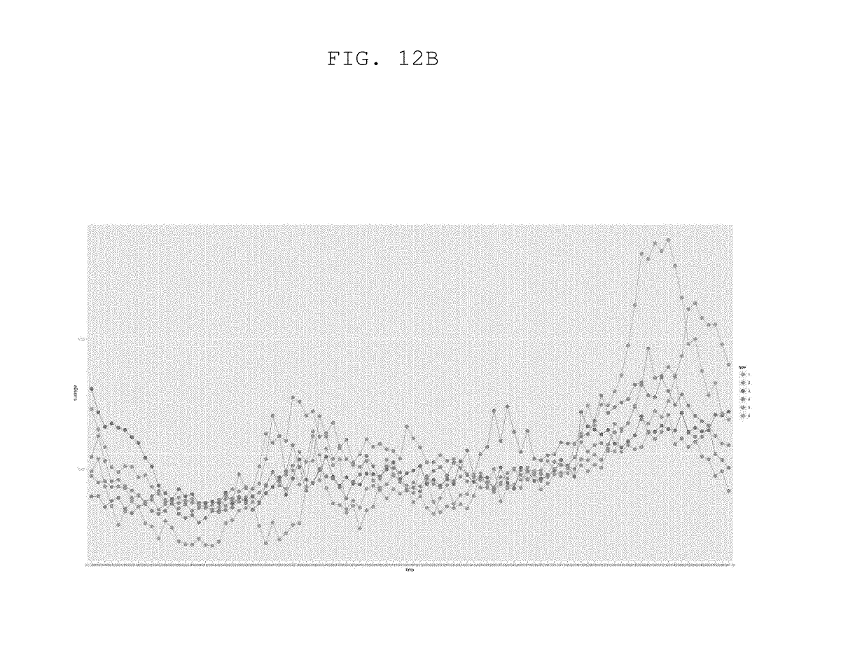

Hereinafter, a user profile generation using a pattern based algorithm according to another exemplary embodiment of the present invention will be described with reference to FIGS. 12A to 14B.

A pattern based algorithm according to the present invention applies “one day power consumption data of a specific site (or a user, a residence, or an address) and “a pattern sample in a power consumption pattern dictionary” to a cluster function to extract an actual power consumption pattern in the specific site.

For example, 24 hours of one day is divided by 15 minutes to be classified into 96 branches and a distance between a usage amount on the pattern sample and an actual usage amount of the specific site may be calculated at every branch. An “Euclidean distance (that is, a square of a difference) may be used as an example of a distance calculating function. In this case, when a plurality of pattern samples (for example, 10 pattern samples_hereinafter, 10-pattern or six pattern samples_hereinafter, 6-pattern) is provided, the distance at every branch of each pattern sample is calculated by the above-described distance calculating function and a sample having the smallest value may be determined as an actual power consumption pattern at the branch. Moreover, when samples are completely assigned to all data, a new center value of data which belongs to each branch of each sample is calculated and a new pattern sample may be generated based on the new center value. Moreover, the above process is repeated on a newly generated pattern sample predetermined times (for example, approximately three times) to secure accuracy for the pattern sample. In this case, the repeated times are limited so that a data processing speed may not be lowered due to the calculating process.

Referring to FIGS. 12A to 14B, a horizontal axis of the graph represents 96 branches obtained by dividing 24 hours by 15 minutes and a vertical axis of the graph represents a ratio of power consumption for 15 minutes corresponding to the branch of total power consumption for one day.

FIGS. 12A and 12B illustrate a plurality of pattern samples which is used for a pattern based algorithm according to an exemplary embodiment of the present invention. Referring to FIG. 12A, with respect to a specific day (for example, Monday or a specific date), 88 families are classified into 10 patterns through an algorithm. Referring to FIG. 12B, 88 families are classified into six patterns with respect to a specific day through an algorithm.

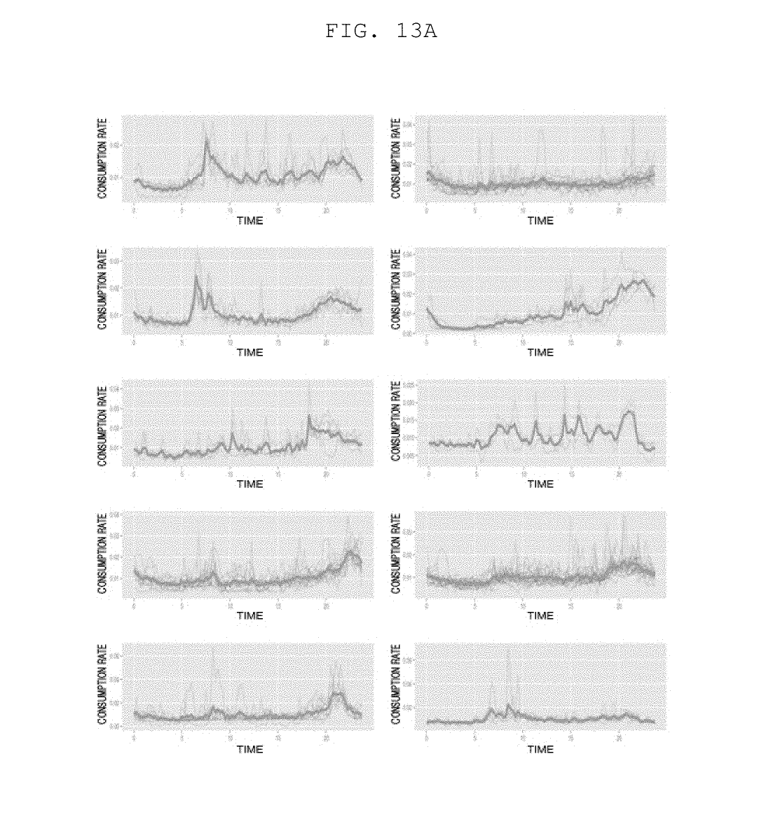

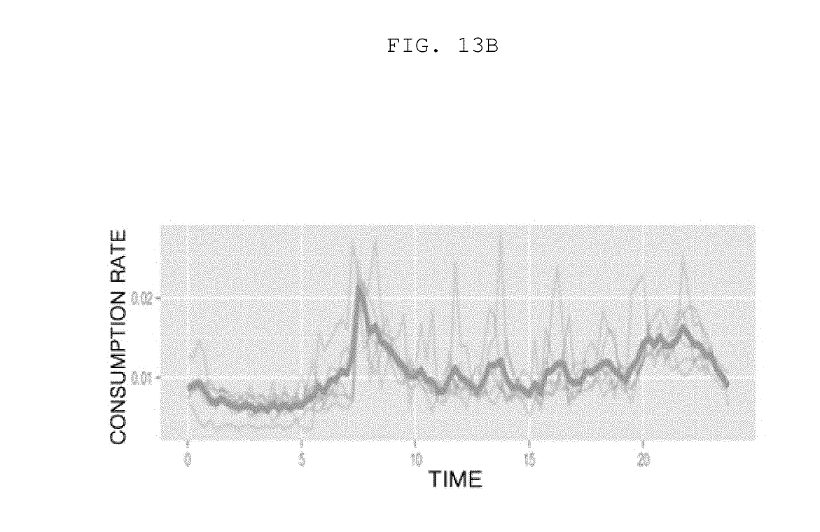

FIGS. 13A and 13B illustrate an actual power consumption pattern generated in accordance with a 10-pattern based algorithm according to an exemplary embodiment of the present invention.

Referring to FIG. 13A, a distance from actual power consumption data at every branch is calculated for each of the ten pattern samples and an actual power consumption pattern is determined by the pattern sample having the smallest value so that an actual power consumption pattern (a graph corresponding to a blue solid line) may be extracted.

For example, referring to FIG. 13B, since power consumption is peak around 7 in the morning, it is determined that a cooking tool having a high power consumption is used when a user gets up in the morning. Further, since the continuous power consumption is maintained during the day time, it is determined that a person stays at home during the day.

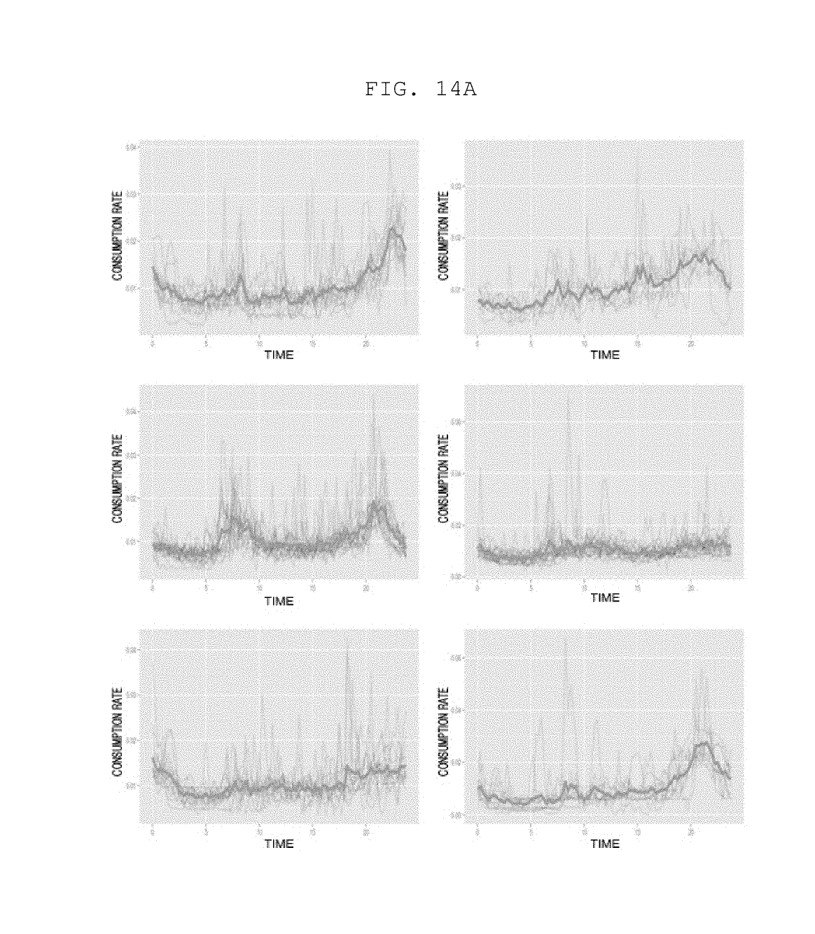

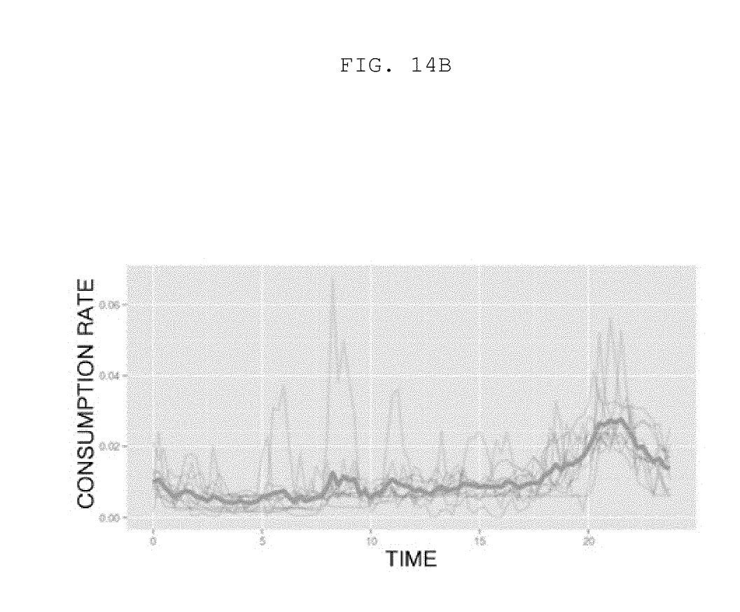

FIGS. 14A and 14B illustrate an actual power consumption pattern generated in accordance with a 6-pattern based algorithm according to an exemplary embodiment of the present invention.

Referring to FIG. 14A, a Euclidian distance from actual power consumption data at every branch is calculated for each of six pattern samples and an actual power consumption pattern is determined by the pattern sample having the smallest value so that an actual power consumption pattern (a graph corresponding to a blue solid line) may be extracted.

Specifically, referring to FIG. 14B, since the power consumption is increased a little bit around seven thirty in the morning, it is considered that the user does not use a cooking tool having high power consumption after getting up. Further, since the power consumption is increased around six in the afternoon, it is assumed that the user prepares for dinner and since the power consumption is further increased around eight in the afternoon, it is determined that more people are at home.

Therefore, the user profile may further include the above-described actual power consumption pattern and a power usage tendency/characteristic based thereon.

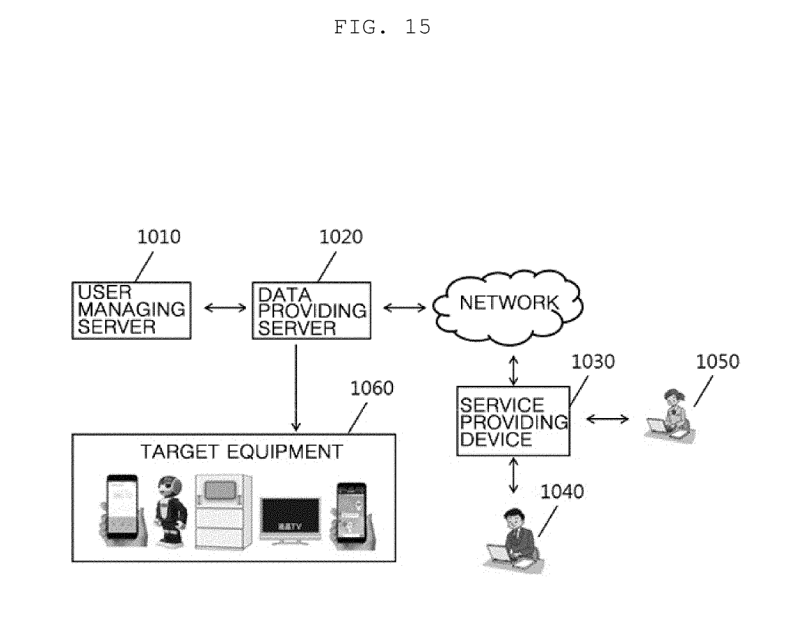

FIG. 15 is a conceptual block diagram of a user customized advertising system according to some exemplary embodiments of the present invention.

Referring to FIG. 15, the user customized advertising system may include a user managing server 1010, a data providing server 1020, and a service providing device 1030.

The user managing server 1010 may be the same as the above-described user managing server 710 of FIG. 7. That is, the user managing server 1010 may generate and store a user profile based on first user information on user identification and second user information on a power consumption pattern.

The data providing server 1020 may access the user profile stored in the user managing server 1010 to search for user information which satisfies a predetermined condition. Further, the data providing server 1020 may receive a request from the service providing device 1030 to perform an operation in accordance with a received request. For example, when the service providing device 1030 requests information on a user which satisfies a specific condition among user profiles stored in the user managing server 1010, the data providing server 1020 processes the request. Further, for example, when the service providing device 1030 requests to transmit advertising contents which is completely approved to the target apparatus 1060 of the user which satisfies a specific condition among the user profiles stored in the user managing server 1010, the data providing server 1020 processes the request.

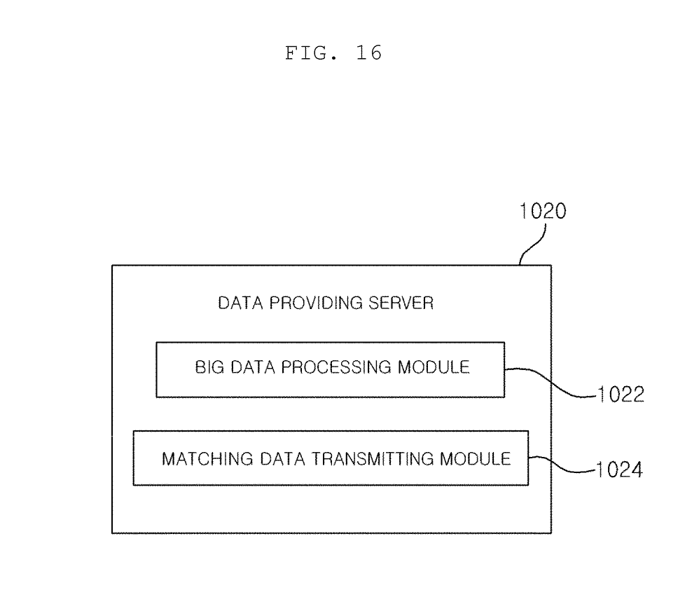

FIG. 16 is a detailed block diagram of a data providing server of FIG. 5.

Referring to FIG. 16, the data providing server 1020 may include a big data processing module 1022 and a matching data transmitting module 1024.

The big data processing module 1022 may process big data related with the user profile stored in the user managing server 1010. For example, the big data processing module 1022 may access the user profile stored in the user managing server 1010 to search for user information which satisfies a predetermined condition.

In some exemplary embodiments, the big data processing module 1022 performs an operation of classifying a user profile stored in the user managing server 1010 in accordance with predetermined criteria (for example, internal criteria) without having a request from the outside.

The matching data transmitting module 1024 may provide the advertising contents which are completely approved to the target apparatus 1060 of the user which satisfies a specific condition among the user profiles stored in the user managing server 1010. For example, when the service providing device 1030 requests to transmit advertising contents which is completely approved to the target apparatus 1060 of the user which satisfies a specific condition among the user profiles stored in the user managing server 1010, the matching data transmitting module 1024 may process the request.

In some exemplary embodiments, the target apparatus 1060 to which completely approved advertising contents are provided may include a home appliance such as a smart phone, a refrigerator, or a television or a mobile messenger, but a technical spirit of the present invention is not limited thereto.

Referring to FIG. 15 again, the user managing server 1010 and the data providing server 1020 may be implemented to be separated from each other as illustrated in the drawing. In this case, there is no way to directly access the user managing server 1010 from the outside, so that a security performance of the system may be improved.

The service providing device 1030 may provide information on a user who satisfies a specific condition among the user profiles stored in the user managing server 1010 to the advertiser 1040. Further, when the advertiser 1040 requests a user who satisfies a specific condition among the user profiles stored in the user managing server 1010 to transmit a specific advertising content, the service providing device 1030 requests an approver 1050 to approve the advertising contents. When the advertising contents are completely approved by the approver 1050, the service providing device 1030 may request the data providing server 1020 to transmit the completely approved advertising contents to the user target apparatus 1060 which satisfies the specific condition, among the user profiles stored in the user managing server 1010.

The service providing device 1030 may be provided as an application which is executed in the mobile apparatus but the present invention is not limited thereto. In some exemplary embodiments, the service providing device 1030 may be provided as software which is executed in a PC such as a desk top.

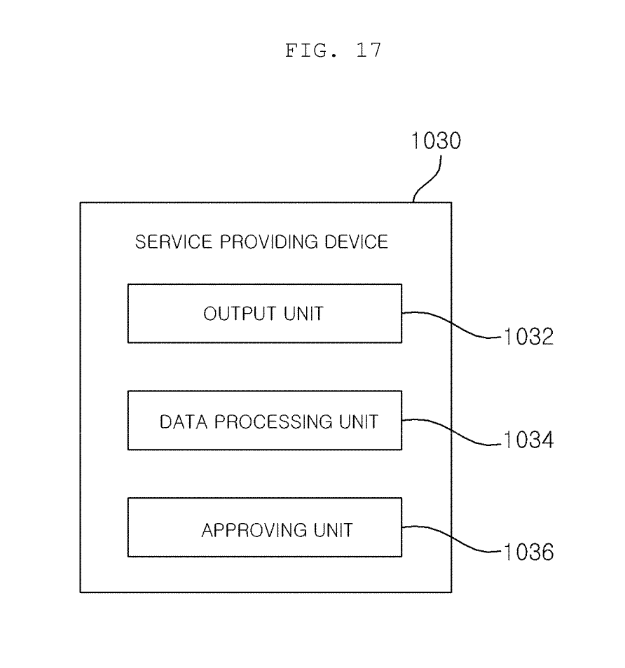

FIG. 17 is a detailed block diagram of a service providing device of FIG. 15.

Referring to FIG. 17, the service providing device 1030 includes an output unit 1032, a data processing unit 1034, and an approving unit 1036.

The output unit 1032 outputs a selection interface which selects a user who satisfies a specific condition to the advertiser 1040 or outputs an approval interface which requests the approver 1050 to request an approval for the advertising contents to the advertiser 1040. Further, the output unit 1032 may receive a specific condition from the advertiser 1040 through the selection interface and receive whether to approve from the approver 1050 through the approval interface.

When a specific condition is provided from the advertiser 1040, the data processing unit 1034 requests the data providing server 1020 information on a user which satisfies the specific condition and when the information on the user is provided from the data providing server 1020, transmits the information to the output unit 1032. Further, when the information on the user which satisfies the specific condition provided from the data providing server 1020 is provided, the data processing unit 1034 classifies the information in accordance with a predetermined criteria (for example, internal criteria) to provide the classified information to the output unit 1032.

When the approving unit 1036 is requested by the advertiser 1040 to transmit the advertising contents to the target apparatus 1060 of the user who satisfies the specific condition, the approving unit 1036 requests the approver 1050 to approve the advertising contents 1036 and checks whether to be approved.

Even though the output unit 1032, the data processing unit 1034, and the approving unit 1036 are separately illustrated in the drawing for the convenience of description, the technical spirit of the present invention is not limited as illustrated. If necessary, the output unit 1032, the data processing unit 1034, and the approving unit 1036 may be implemented by more divided modules or in contrast, implemented to be integrated as one module.

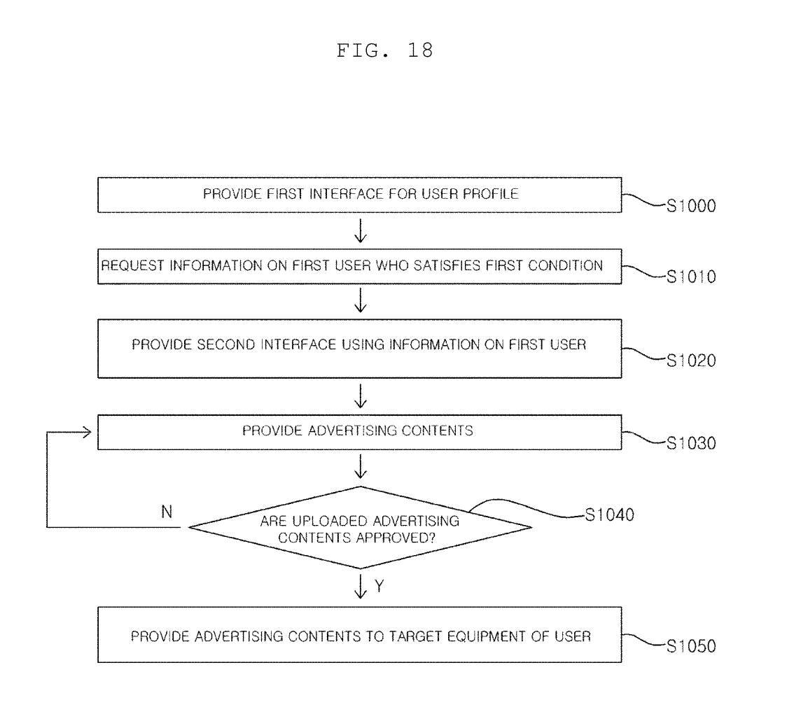

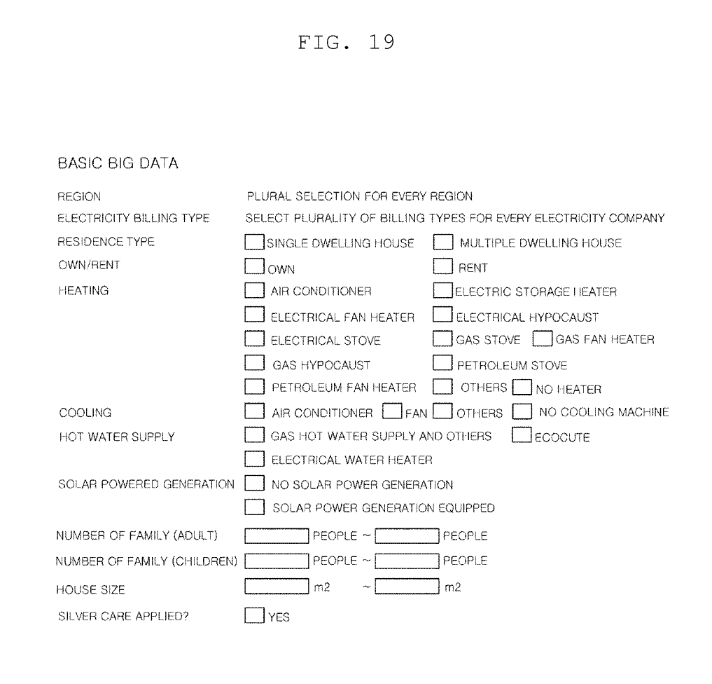

FIG. 18 is a flowchart of a method for providing a user customized advertisement according to some exemplary embodiments of the present invention. FIGS. 19 to 24 are views for explaining a method for providing a user customized advertisement according to some exemplary embodiments of the present invention.

Referring to FIGS. 15 and 18, a first interface for a user profile is provided in step S1000.

Specifically, the service providing device 1030 may provide the first interface as illustrated in FIGS. 19 to 22 to the advertiser 1040.

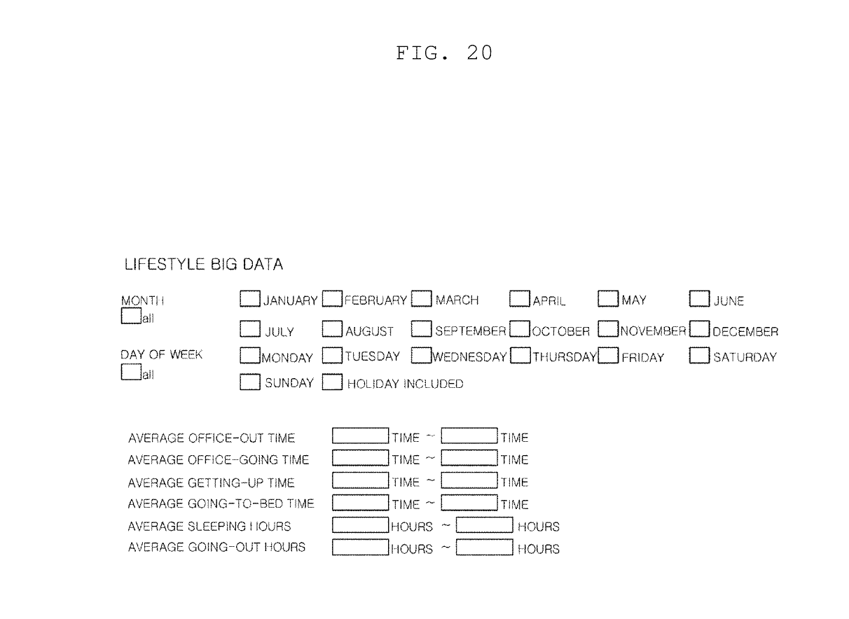

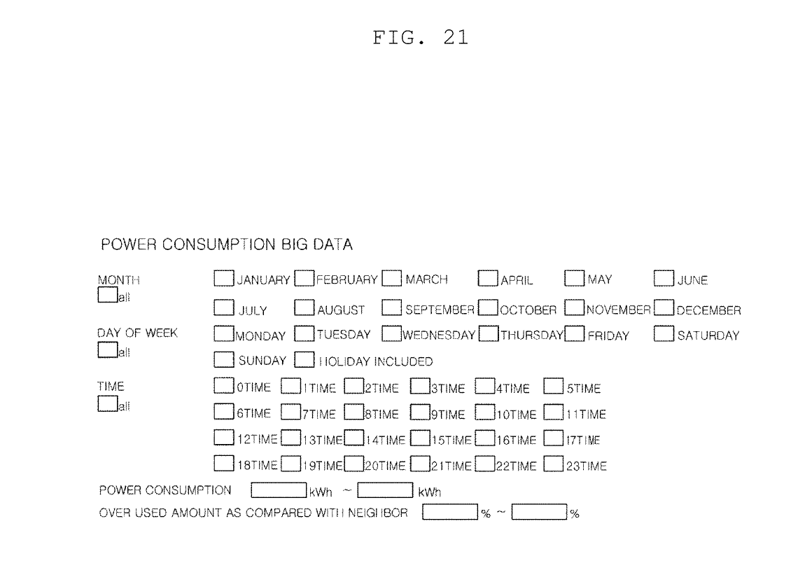

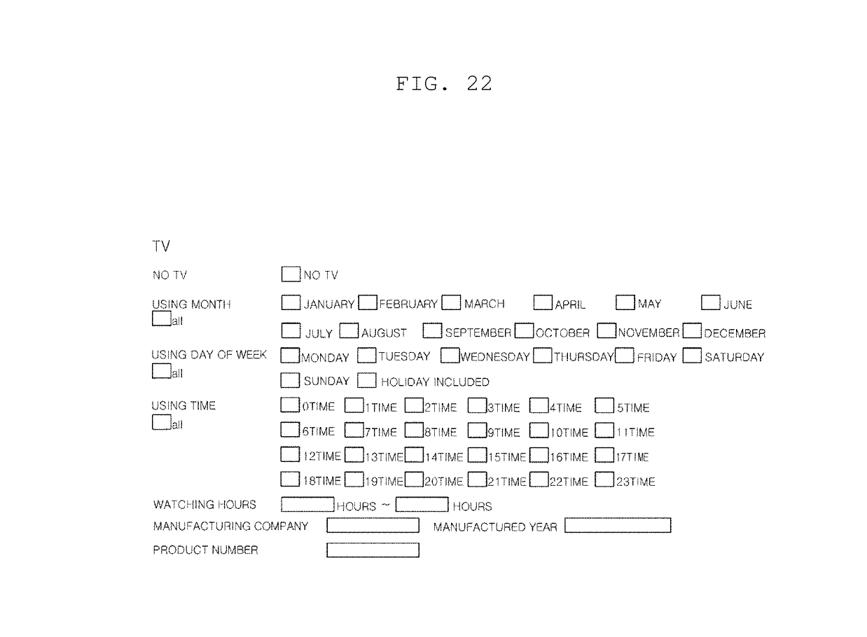

By doing this, the advertiser 1040 may select a condition for a target to be advertised by the advertiser 1040. For example, the residence type, whether to possess home appliances, or a family type of a target to be advertised may be selected through a basic big data category as illustrated in FIG. 19. Further, an average commuting time and an average getting-up time and sleeping time of a target to be advertised may be selected through a lifestyle big data category as illustrated in FIG. 20. Further, power consumption of the target to be advertised may be selected through a power consumption big data category as illustrated in FIG. 21 and a detailed usage pattern of home appliances to be advertised may be selected through a detailed home appliance usage pattern (for example, TV) category as illustrated in FIG. 22.

The first interface is just one example and the service providing device 1030 may provide another type of selection interface which selects a condition of classifying a user profile stored in the data providing server 1020 to the advertiser 1040.

Next, referring to FIGS. 15 and 18, information on the first user who satisfies the first condition is requested in step S1010.

Specifically, the service providing device 1030 provides the first condition input through the first selection interface by the advertiser 1040 to the data providing server 1020 and requests the data providing server 1020 of information on a user who satisfies a first condition among the user profile stored in the user managing server 1010. The data providing server 1020 which receives the request accesses the user server 1010 to provide information on the user who satisfies the first condition to the service providing device 1030.

Next, referring to FIGS. 15 and 18, a second interface is provided using information on the first user in step S1020. The advertising contents are provided from the advertiser in step S1030.

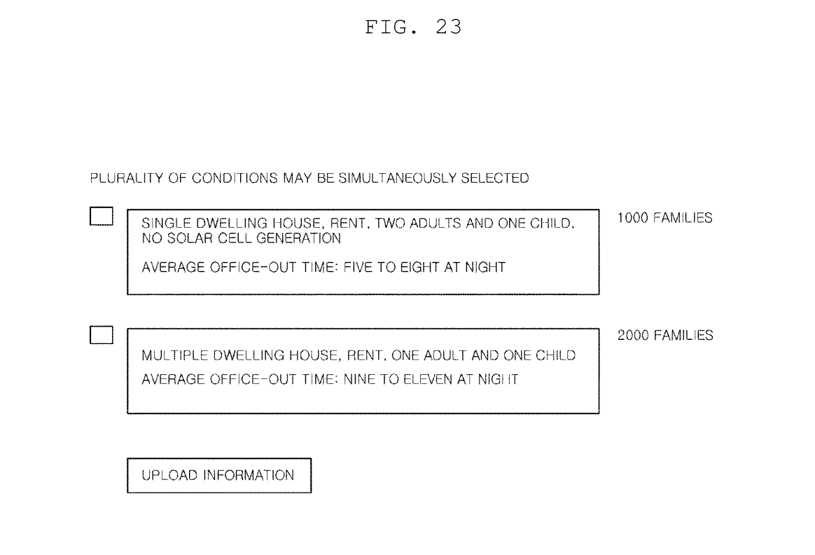

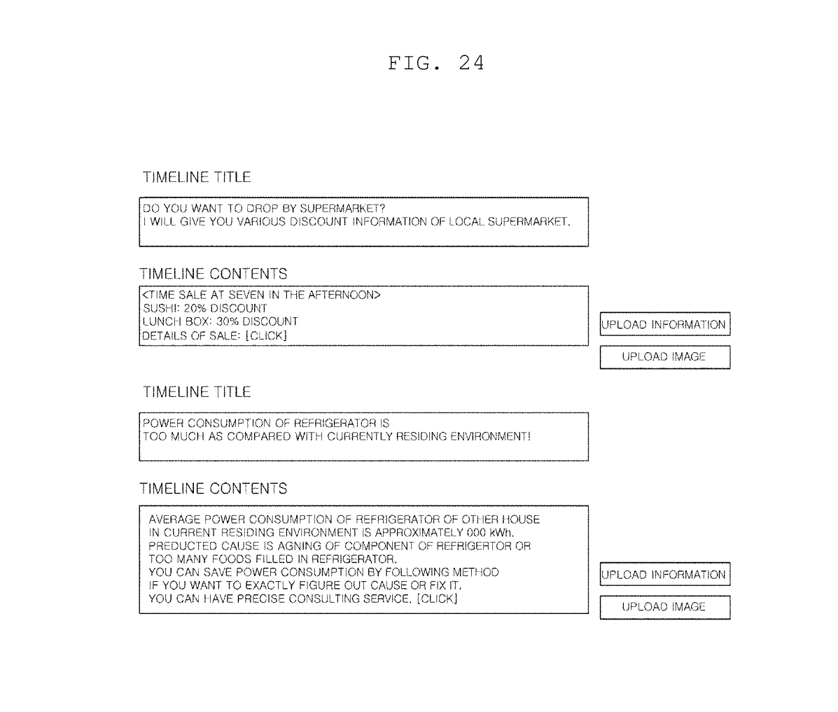

Specifically, the service providing device 1030 may provide the second interface as illustrated in FIG. 23 to the advertiser 1040 using information on the first user which is provided from the data providing server 1020. In some exemplary embodiments, information on the first user which is provided to the advertiser 1040 through the second interface as illustrated in FIG. 23 may be different from the information previously provided through the first interface. Further, the service providing device 1030 may be provided with advertising contents which will be provided to a target to be advertised from the advertiser 1040 through the second interface as illustrated in FIG. 24. The advertiser 1040 selects a target to be advertised through the second interface such as illustrated in FIGS. 23 and 24 and uploads the advertising contents for the target.

Next, referring to FIGS. 15 and 18, approval for the uploaded advertising contents is requested and whether to be approved is determined in step S1040. When the approval is completed, the advertising contents are provided to the target apparatus of the user in step S1050.

Specifically, the service providing device 1030 uses the approval interface to request the approver 1050 to approve the uploaded advertising contents. In some exemplary embodiments, the approver 1050 may include a manufacturing company of the advertising target apparatus 1060.

When the approval from the approver 1050 is completed, the service providing device 1030 requests the data providing server 1020 to provide the advertising contents to the target apparatus of the user selected by the advertiser 1040. By doing this, the data providing server 1020 may transmit the advertising contents in which the approval is completed to the target apparatus of the user selected by the advertiser 1040.

When the approval from the approver 1050 is not completed, the service providing device 1030 does not request the data providing server 1020 to provide the advertising contents to the target apparatus of the user selected by the advertiser 1040 but requests the advertiser 1040 to upload the advertising contents again.

In the user customized advertising system according to the technical spirit of the present invention, the advertiser 1040 advertises to a user which is suitable for the advertisement rather than random people so that the efficiency of the advertisement may be maximized. Further, in the user customized advertising system according to the technical spirit of the present invention, for example, only the advertising contents which are completely approved by the manufacturing company of the advertising target apparatus 1060 is transmitted as an advertisement so that a problem in that a product image of the advertising target apparatus 1060 deteriorates may be blocked in advance.

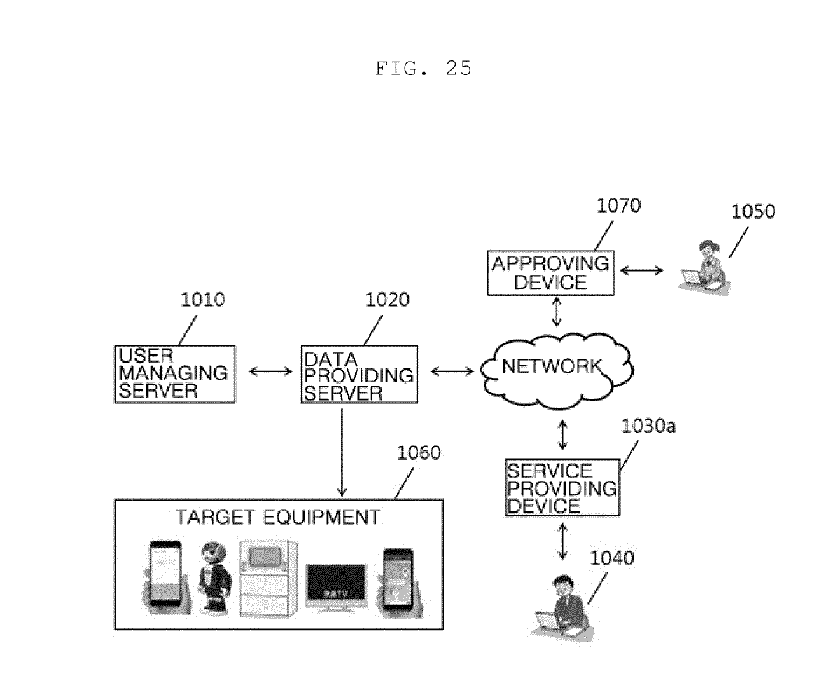

FIG. 25 is a conceptual block diagram of a user customized advertising system according to other some exemplary embodiments of the present invention. Hereinafter, a difference from the exemplary embodiment which is described above with reference to FIG. 15 will be mainly described.

Referring to FIG. 25, in the user customized advertising system according to the present exemplary embodiment, an approving device 1070 and a service providing device 1030a are implemented to be separated. Here, the approving device 1070 may be implemented as a company server of the approver 1050 and may be implement as a separate application or software which is different from the service providing device 1030a. In this case, differently from the above-described exemplary embodiment, the service providing device 1030a requests an approval signal which requests to approve the advertising contents provided from the advertiser 1040 to the approving device 1070 and the approving device 1070 provides a signal related with approval reason to the service providing device 1030a or the data providing server 1020.

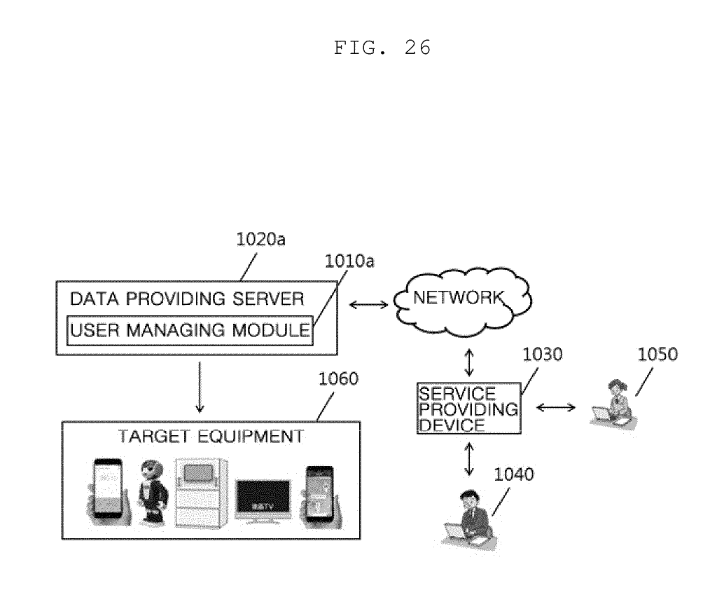

FIG. 26 is a conceptual block diagram of a user customized advertising system according to other some exemplary embodiments of the present invention. Hereinafter, a difference from the exemplary embodiment which is described with reference to FIG. 15 will be mainly described.

Referring to FIG. 26, in the user customized advertising system according to the present exemplary embodiment, the data providing server 1020a includes the user managing module 1010a. That is, as illustrated in FIG. 15, the user managing server 1010 and the data providing server 1020 are not implemented to be separated so that data processing efficiency may be improved.

The above description illustrates a technical spirit of the present invention as an example and various changes, modifications, and substitutions become apparent to those skilled in the art without departing from a scope of an essential characteristic of the present invention.

Therefore, as is evident from the foregoing description, the exemplary embodiments and accompanying drawings disclosed in the present invention do not limit the technical spirit of the present invention and the scope of the technical spirit of the present invention is not limited by the exemplary embodiments and accompanying drawings. The protection scope of the present invention should be interpreted based on the following appended claims and it should be appreciated that all technical spirits included within a range equivalent thereto are included in the scope of the present invention.

What is claimed is:

1. A system for providing a user customized advertisement, comprising:
a user managing server which generates a user profile based on first user information on user identification and second user information on a power consumption pattern;
an advertisement providing server which selects a user customized advertisement based on the generated user profile; and
a user terminal which receives and outputs the selected user customized advertisement from the advertisement providing device.

2. The system according to claim 1, wherein the first user information includes at least one of a name, an ID, a gender, an address, load apparatus identification information, and favorite information and the second user information is information on power consumption of a user for every load apparatus and includes at least one of power information at every time zone, status information, and frequency information.

3. The system according to claim 1, wherein the user profile includes at least one of a user's behavior and a user's tendency which are estimated based on the first and second user information.

4. The system according to claim 3, wherein the user managing server predicts a user's demand based on at least one of the user's behavior and the user's tendency estimated above and transmits the predicted user's demand to the advertisement providing server and the advertisement providing server selects the user customized advertisement in consideration of the predicted user demand.

5. The system according to claim 1, wherein the user managing server collects the user's current status information to transmit the information to the advertisement providing server and the advertisement providing server selects the user customized advertisement in consideration of the current status information of the user.

6. The system according to claim 1, wherein the user managing server generates the user profile based on a pattern based algorithm.

7. The system according to claim 6, wherein the pattern based algorithm calculates a Euclidean distance between a sample and an actual power consumption.

8. The system according to claim 6, wherein the user managing server figures out at least one of the power consumption pattern and the power consumption characteristic for every user using the pattern based algorithm and reflects at least one of the figured-out power consumption pattern and power consumption characteristic to generate the user profile.

9. The system according to claim 1, further comprising:
an energy measuring apparatus which obtains a data set on power consumption in accordance with an operation status of each of load apparatus of the user or a changing pattern of the operation status,
wherein the user managing server labels the data set received from the energy measuring apparatus and obtains the second user information from the labeled data set.

10. The system according to claim 1, further comprising:
an energy measuring apparatus which obtains a data set on power consumption in accordance with an operation status of each of load apparatus of the user or a changing pattern of the operation status; and
a labeling server which labels the data set received from the energy measuring apparatus,
wherein the user managing server receives the data set labeled from the labeling server and obtains the second user information from the received labeled data set.

11. The system according to claim 1, wherein the user managing server performs security communication with at least one of the user terminal, the advertisement providing server, the energy measuring apparatus, and the labeling server.

12. A user managing server which provides a user customized advertisement, the user managing server, comprising:
a user information managing module which obtains and manages first user information on user identification and second user information on a power consumption pattern;
a user profile generating module which generates a user profile based on the first and second user information;
a communication module which transmits predetermined information required to select a user customized advertisement based on the user profile to the advertisement providing server; and
a control module which controls an operation of at least one of the user information managing module, the user profile generating module, and the communication module.

13. The server according to claim 12, wherein the user information managing module includes: a first user information managing module which obtains and manages the first information including at least one of a name, an ID, a gender, an address, load apparatus identification number, and favorite information, and
a second user information managing module which obtains and manages the second user information including at least one of power information at every time zone, status information, and frequency information as information on power consumption of a user for every load apparatus.

14. The server according to claim 12, wherein the user profile generating module predicts at least one of the user's behavior and the user's tendency based on the first and second user information and reflects at least one of the predicted user's behavior and user's tendency to the user profile.

15. The server according to claim 14, further comprising:
a user demand predicting module which predicts a user demand based on at least one of the predicted user's behavior and user's tendency in accordance with the control of the control module,
wherein the communication module transmits the predicted user demand to the advertisement providing server to be considered to select the user customized advertisement.

16. The server according to claim 12, wherein the user profile generating module generates the user profile based on a pattern based algorithm.

17. The server according to claim 16, wherein the pattern based algorithm calculates a Euclidean distance between a sample and an actual power consumption.

18. The server according to claim 12, further comprising:
a user status collecting module which collects the user's current status information,
wherein the communication module transmits the collected user's current status information to the advertisement providing server to be considered to select the user customized advertisement.

19. The server according to claim 12, further comprising:
a labeling module which labels a data set which matches an operation status of each load apparatus of the user or a changing pattern of the operation status,
wherein the user information managing module obtains the second user information from the labeled data set.

20. The server according to claim 12, wherein the communication module receives a data set which matches an operation status of each load apparatus of the user or a changing pattern of the operation status from the labeling server, and the user information managing module obtains the second user information from the received data set.

21. The server according to claim 12, wherein the communication module performs security communication with at least one of the advertisement providing server, the energy measuring apparatus, the labeling server, and the user terminal.

22. A method for providing a user customized advertisement, the method comprising:
obtaining first user information on user identification and second user information on a power consumption pattern;
generating a user profile based on the obtained first and second user information;
selecting a user customized advertisement based on the generated user profile; and
transmitting the selected user customized advertisement to a user terminal.

23. The method according to claim 22, wherein the generating includes: predicting at least one of a user's behavior and a user's tendency based on the first and second user information; and
reflecting at least one of the predicted user's behavior and user's tendency to the user profile.

24. The method according to claim 23, further comprising:
predicting a user's demand based on at least one of the predicted user's behavior and user's tendency,
wherein in the selecting, the user customized advertisement is selected in consideration of the predicted user demand.

25. The method according to claim 22, wherein in the generating, the user profile is generated using a pattern based algorithm.

26. The method according to claim 25, wherein the pattern based algorithm calculates a Euclidean distance between a sample and an actual power consumption.

27. The method according to claim 22, further comprising:
collecting current status information of the user,
wherein in the selecting, the user customized advertisement is selected in consideration of the collected current status of the user.

28. The method according to claim 22, further comprising:
collecting a data set on power consumption in accordance with an operation status of each of load apparatus of the user or a changing pattern of the operation status; and
labeling the collected data set,
wherein in the obtaining, the second user information is obtained from the labeled data set.

29. A method for providing a user customized advertisement, the method comprising:
providing a first interface on a user profile, by a service providing device;
requesting information on a first user who satisfies a first condition among the user profile based on the first condition input through the first interface to the data providing server, by the service providing device;
providing a second interface using information on a first user provided from the data providing server, by the service providing device;
requesting an approval based on advertisement contents input through the second interface, by the service providing device; and
requesting the data server to provide the advertising contents to target apparatus when the approval is completed, by the service providing device.

30. The method according to claim 29, wherein the requesting of approval includes outputting the approved interface through an output unit and requesting the approval through the output approved interface by the service providing device.

31. The method according to claim 29, wherein the requesting of approval includes requesting an approval signal to an approving device, by the service providing device.

32. The method according to claim 29, wherein the second interface classifies and outputs the information on the first user in accordance with the second condition which is different from the first condition.

33. The method according to claim 29, further comprising:
providing the advertisement contents to the target apparatus when the approval is completed, by the data providing server.

34. A method for providing a user customized advertisement, comprising:
receiving the first condition, by a data providing server, to provide information on a first user which satisfies the first condition among user profiles to a service providing device; and
receiving the completely approved advertising contents by the data providing server to provide the completely approved advertising contents to the target apparatus.

35. The method according to claim 34, wherein the receiving of the completely approved advertising contents, by the data providing server, includes receiving the advertising contents and an approval signal indicating that the advertising contents is approved by an approver.

36. A user customized advertising system, comprising:
a data providing server which provides information on a first user who satisfies the first condition among user profiles generated based on the information on user identification and information on a power consumption pattern and receives the advertising contents to provide the advertising contents to a target device; and
a service providing device which requests the information on the first user who satisfies a first condition to the data providing server and receives the advertising contents using information on the first user to request to approve the advertising contents,
wherein the advertising contents which are provided by the data providing server to the target device are advertising contents which is completely approved as requested by the service providing device.

37. The system according to claim 36, wherein the service providing device includes:
an output unit which outputs an interface which receives the first condition and the advertising contents;
a data processing unit which provides an input provided through the output unit to the data providing server; and
an approving unit which requests an approval on the input advertising contents and provides the result to the data providing server.

38. The system according to claim 36, further comprising:
an approving device which processes an approval of the advertising contents.
